(19) United States
(12) Patent Application Publication
(10) Pub. No.: US 2023/0002633 A1
(43) Pub. Date: Jan. 5, 2023

(54) MULTI-FLUID KIT FOR INKJET TEXTILE PRINTING

(71) Applicant: HEWLETT-PACKARD DEVELOPMENT COMPANY, L.P., Spring, TX (US)

(72) Inventors: Dennis Z. Guo, San Diego, CA (US); Jie Zheng, San Diego, CA (US)

(21) Appl. No.: 17/351,966

(22) Filed: Jun. 18, 2021

(51) Int. Cl. C09D 11/54; B41J 2/21; B41J 3/407; B41M 5/00; D06P 5/30; D06P 1/44; D06P 1/50; C09D 11/38

(52) U.S. Cl. CPC C09D 11/54; B41J 2/2117; B41J 3/4078; B41M 5/0017; D06P 5/30; D06P 1/445; D06P 1/50; C09D 11/38; B82Y 30/00

(57) ABSTRACT

An example of a multi-fluid kit includes a pretreatment fluid, a fixer fluid, and a white inkjet ink. The pretreatment fluid includes anionically modified cellulose nanocrystals and a first aqueous vehicle. In some examples, the fixer fluid includes an azetidinium-containing polyamine and a second aqueous vehicle. The multi-fluid kit is suitable for use in inkjet textile printing.

### BACKGROUND

Textile printing methods often include rotary and/or flat-screen printing. Traditional analog printing typically involves the creation of a plate or a screen, i.e., an actual physical image from which ink is transferred to the textile. Both rotary and flat screen printing have great volume throughput capacity, but also have limitations on the maximum image size that can be printed. For large images, pattern repeats are used. Conversely, digital inkjet printing enables greater flexibility in the printing process, where images of any desirable size can be printed immediately from an electronic image without pattern repeats. Inkjet printers are gaining acceptance for digital textile printing. Inkjet printing is a non-impact printing method that utilizes electronic signals to control and direct droplets or a stream of ink to be deposited on media.

### BRIEF DESCRIPTION OF THE DRAWINGS

Features of examples of the present disclosure will become apparent by reference to the following detailed description and drawings.

FIG. 1 is a schematic illustration of an example multi-fluid kit and an example textile printing kit;

FIG. 2 is a schematic diagram of an example of a printing system and different examples of the printing method;

FIG. 3 depicts Turn-On-Energy (TOE) curves for three example pretreatment fluids, plotting drop weight in nanograms (ng) vs. firing energy in microJoules (pJ); and

FIG. 4A through FIG. 10B are black and white reproductions of originally colored photographs of comparative prints (FIG. 4A through FIG. 7B) generated with different comparative pretreatment fluids and example prints (FIG. 8A through FIG. 10B) generated with different example pretreatment fluids, illustrating an improvement in opacity for each of the example prints as compared to the comparative prints.

### DETAILED DESCRIPTION

The textile industry is a major industry, and printing on textiles, such as cotton, polyester, etc., has been evolving to include digital printing methods. Some digital printing methods enable direct to garment (or other textile) printing. White ink is one of the most heavily used inks in direct to garment printing. More than two-thirds of the direct to garment printing that is performed utilizes a white ink on a colored textile. Obtaining white images with desirable opacity has proven to be challenging, in part because different textile fabrics introduce different obstacles that can affect the white print. As an example, cotton fabrics are more likely than polyester fabrics to have fibrillation (e.g., hair-like fibers sticking out of the fabric surface).

Disclosed herein is a multi-fluid kit that is particularly suitable for obtaining white images, which may have desirable opacity, durability (i.e., washfastness), and quality. Examples of the multi-fluid kit include a pretreatment fluid, a fixer fluid, and a white inkjet ink. The pretreatment fluid includes anionically modified cellulose nanocrystals, which interact with positively charged groups of a cationic polymer in the fixer fluid to form a gel. This gel forms a film that blocks pores of the textile fabric. As such, the gel film allows the pigment of the white inkjet ink to be fixed at or near the surface of the textile fabric, which improves the opacity of the white image that is formed. Moreover, the gel film may be able to hold the hair-like fibers of the cotton textile fabric, which reduces fibrillation and improves image quality.

The opacity may be measured in terms of L*, i.e., lightness, of a white print generated on a colored textile fabric. A greater L* value indicates a greater opacity of the white ink on the colored textile fabric. L* is measured in the CIELAB color space, and may be measured using any suitable color measurement instrument (such as those available from HunterLab or X-Rite). The white inkjet ink, when printed on the colored textile fabric pretreated with the pretreatment fluid and the fixer fluid disclosed herein, may generate prints that have a desirable L* value.

The durability of a print on a textile fabric may be assessed by its ability to retain color after being exposed to washing. This is also known as washfastness. Washfastness can be measured in terms of a change in L* before and after washing.

The fluid(s) and/or white inkjet ink disclosed herein may include different components with different acid numbers. As used herein, the term “acid number” refers to the mass of potassium hydroxide (KOH) in milligrams that is used to neutralize one (1) gram of a particular substance. The test for determining the acid number of a particular substance may vary, depending on the substance. For example, to determine the acid number of a polyurethane-based binder, a known amount of a sample of the binder may be dispersed in water and the aqueous dispersion may be titrated with a polyelectrolyte titrant of a known concentration. In this example, a current detector for colloidal charge measurement may be used. An example of a current detector is the MUtek PCD-05 Smart Particle Charge Detector (available from BTG). The current detector measures colloidal substances in an aqueous sample by detecting the streaming potential as the sample is titrated with the polyelectrolyte titrant to the point of zero charge. An example of a suitable polyelectrolyte titrant is poly(diallyldimethylammonium chloride) (i.e., PolyDADMAC). It is to be understood that any suitable test for a particular component may be used.

Throughout this disclosure, a weight percentage that is referred to as “wt % active” refers to the loading of an active component of a dispersion or other formulation that is present in the pretreatment fluid, the fixer fluid, or the white inkjet ink. For example, the white pigment may be present in a water-based formulation (e.g., a stock solution or dispersion) before being incorporated into the white inkjet ink. In this example, the wt % actives of the white pigment accounts for the loading (as a weight percent) of the white pigment that is present in the white inkjet ink, and does not account for the weight of the other components (e.g., water, etc.) that are present in the formulation with the white pigment. The term “wt %,” without the term actives, refers to the loading (in the pretreatment fluid, the fixer fluid, or the white inkjet ink) of a 100% active component that does not include other non-active components therein.

The term “molecular weight” as used herein refers to weight average molecular weight (Mw), the units of which are g/mol or Daltons.

The viscosity measurements set forth herein represent those measured by a viscometer at a particular temperature and at a particular shear rate (s⁻¹) or at a particular speed. The temperature and shear rate or temperature and speed are identified with individual values. Viscosity may be measured, for example, by a VISCOLITE™ viscometer (from Hydromotion) or another suitable instrument.

In some examples, the term “on” may mean that one component or material is positioned directly on another component or material. When one is directly on another, the two are in contact with each other. For example, the fixer fluid may be applied on the textile fabric so that it is directly on and in contact with the textile fabric.

In other examples, the term “on” may mean that one component or material is positioned indirectly on another component or material. By indirectly on, it is meant that an additional component or material may be positioned between the two components or materials. For example, the pretreatment fluid may be applied on the fixer fluid which has been applied on the textile fabric, and thus the pretreatment fluid may be considered to be on, or in indirect contact with, the textile fabric.

Sets and Kits

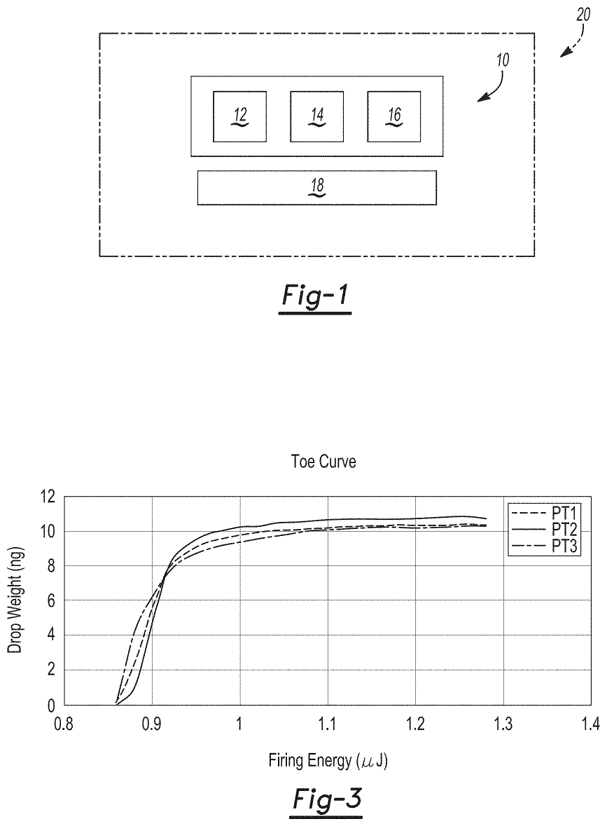

Examples of the multi-fluid kit disclosed herein are shown schematically in FIG. 1. One example of the multi-fluid kit 10 for inkjet textile printing includes a pretreatment fluid 12 including anionically modified cellulose nanocrystals and a first aqueous vehicle; a fixer fluid 14; and a white inkjet ink 16. In one specific example, the multi-fluid kit 10 for inkjet textile printing includes a pretreatment fluid 12 including anionically modified cellulose nanocrystals and a first aqueous vehicle; a fixer fluid 14 including an azetidinium-containing polyamine and a second aqueous vehicle; and a white inkjet ink 16. Several examples of each of the fluids 12, 14, 16 are disclosed herein, and it is to be understood that any example of the pretreatment fluid 12, the fixer fluid 14, and the white inkjet ink 16 may be used in the examples of the multi-fluid kit 10.

In the multi-fluid kit 10, the pretreatment fluid 12, the fixer fluid 14, and the white inkjet ink 16 are maintained separately until utilized together in a printing method. As such, the pretreatment fluid 12, the fixer fluid 14, and the white inkjet ink 16 may be maintained in separate containers (e.g., respective reservoirs/fluid supplies of respective inkjet cartridges) or separate compartments (e.g., respective reservoirs/fluid supplies) in a single container (e.g., inkjet cartridge).

In the examples disclosed herein, the multi-fluid kit 10 includes a pretreatment fluid 12 that is formulated for digital application (e.g., by a thermal or piezoelectric inkjet printhead) and a white inkjet ink 16 that is also formulated for digital application. In some examples, the fixer fluid 14 is also formulated for digital application. In some instances, each of the fluids 12, 14, 16 is a thermal inkjet fluid, and thus can be digitally applied via a thermal inkjet printer.

Examples of the fluid kit 10 may also be part of a kit 20 for textile printing, which is also shown schematically in FIG. 1. In an example, the textile printing kit 20 includes a textile fabric 18 selected from the group consisting of polyester fabrics, polyester blend fabrics, cotton fabrics, cotton blend fabrics, nylon fabrics, nylon blend fabrics, silk fabrics, silk blend fabrics, wool fabrics, wool blend fabrics, and combinations thereof; a pretreatment fluid 12 including anionically modified cellulose nanocrystals and a first aqueous vehicle; a fixer fluid 14; and a white inkjet ink 16. In a more specific example, the textile printing kit 20 includes a textile fabric 18 selected from the group consisting of polyester fabrics, polyester blend fabrics, cotton fabrics, cotton blend fabrics, nylon fabrics, nylon blend fabrics, silk fabrics, silk blend fabrics, wool fabrics, wool blend fabrics, and combinations thereof; a pretreatment fluid 12 including anionically modified cellulose nanocrystals and a first aqueous vehicle; a fixer fluid 14 including an azetidinium-containing polyamine and a second aqueous vehicle; and a white inkjet ink 16. It is to be understood that any example of the pretreatment fluid 12, the fixer fluid 14, and the white inkjet ink 16 disclosed herein may be used in the examples of the textile printing kit 20.

Pretreatment Fluid

The pretreatment fluid 12 includes anionically modified cellulose nanocrystals and an aqueous vehicle. This aqueous vehicle may be referred to herein as the “first aqueous vehicle” or the “pretreatment aqueous vehicle.”

Cellulose nanocrystals (CNCs) are organic nanocrystals that are isolated from natural sources, such as wood, bark, plants, etc. The cellulose nanocrystals used in the pretreatment fluid 12 are anionically modified cellulose nanocrystals, which may be manufactured by the hydrolytic extraction of natural cellulose material with an acid, such as an organic carboxylic acid (e.g., a citric acid, maleic acid, fumaric acid, oxalic acid, malonic acid, etc.) or sulfuric acid (H₂SO₄). As a result of acid hydrolysis and esterification, a fraction of the hydroxy (—OH) groups of natural cellulose are esterified by the acid, which incorporates anionic carboxylate (—O—CO₂⁻) or sulfonate (—O—SO₃⁻) groups on the surface of the nanocrystals. Thus, depending upon the acid used in manufacturing, the anionically modified cellulose nanocrystals include carboxylate groups or sulfonate groups. The number of anionic groups depends upon the concentration of the acid and the hydrolysis time.

Structurally, the anionically modified cellulose nanocrystals are rod-like anisotropic nanocrystals having an aspect ratio (ratio of length to width) as high as 100. In an example, a length of the anionically modified cellulose nanocrystals ranges from about 100 nm to about 200 nm, and a width ranges from about 2 nm to about 20 nm. In another example, the length of the anionically modified cellulose nanocrystals ranges from about 150 nm to about 200 nm, and the width ranges from about 5 nm to about 20 nm. The hydrodynamic radius (used to determine width) of the cellulose nanocrystals may be determined using a light scattering tool. Other suitable tools that may be used to measure the length and width of the cellulose nanocrystals include TEM (Transmission Electron Microscopy), AFM (Atomic Force Microscopy), and DLS (Dynamic Light Scattering).

The anionically modified cellulose nanocrystals may be incorporated into the pretreatment fluid 12 as a dry powder or in the form of a suspension. Suitable anionically modified cellulose nanocrystal suspensions are available from the University of Maine Process Development Center or from Celluforce Inc. (located in Montreal, Quebec, Calif.).

The anionically modified cellulose nanocrystals may be present in the pretreatment fluid 12 in an amount ranging from about 0.5 wt % active to about 10 wt % active based on a total weight of the pretreatment fluid. As other examples, the anionically modified cellulose nanocrystals may be present in the pretreatment fluid 12 in an amount ranging from about 1 wt % active to about 9 wt % active, from about 2 wt % active to about 6 wt % active, etc.

The pretreatment fluid 12 may be prepared by adding the desired amount of the anionically modified cellulose nanocrystals to the first aqueous vehicle. The anionically modified cellulose nanocrystals dissolve in the first aqueous vehicle.

In some examples, the first aqueous vehicle (the pretreatment aqueous vehicle) consists of water; and the pretreatment fluid 12 consists of the anionically modified cellulose nanocrystals and the first aqueous vehicle. In these examples, the pretreatment fluid 12 consists of the anionically modified cellulose nanocrystals and the water. In this example, the pretreatment fluid 12 includes no other components.

In other examples, the pretreatment fluid 12 may include other additives. In these examples, the first aqueous vehicle includes water and an additive selected from the group consisting of a co-solvent, a non-ionic surfactant, an antimicrobial agent, a pH adjuster, and combinations thereof. In some examples, the pretreatment fluid 12 consists of the water, the anionically modified cellulose nanocrystals, and the pH adjuster. In other examples, the pretreatment fluid 12 consists of the water, the anionically modified cellulose nanocrystals, and any one or more of the listed additives.

The pretreatment fluid 12 has a pH ranging from about 5 to about 12. Suitable pH ranges for examples of the pretreatment fluid 12 may include from about 6 to about 8, or from about 9 to about 11. In one example, the pH of the pretreatment fluid 12 is about 6.5. In some instances, a pH adjuster may be added to the pretreatment fluid 12 to obtain the desired pH. Examples of suitable pH adjusters for the pretreatment fluid 12 include metal hydroxide bases, such as potassium hydroxide (KOH), sodium hydroxide (NaOH), etc. Other examples of suitable pH adjusters for the pretreatment fluid 12 include acids, such as nitric acid or methanesulfonic acid, etc. In an example, the metal hydroxide base or the acid may be added to the pretreatment fluid 12 in an aqueous solution, such as an aqueous solution including 5 wt % of the metal hydroxide base (e.g., a 5 wt % active potassium hydroxide aqueous solution) or including 99% methanesulfonic acid (e.g., a 99 wt % active methanesulfonic acid aqueous solution).

In an example, the total amount of pH adjuster(s) in the pretreatment fluid 12 ranges from greater than 0 wt % to about 0.5 wt % (based on the total weight of the pretreatment fluid 12). In another example, the total amount of pH adjuster(s) in the pretreatment fluid 12 ranges from about 0.01 wt % to about 0.2 wt %. In another example, the total amount of pH adjuster(s) in the pretreatment fluid 12 is about 0.03 wt % (based on the total weight of the pretreatment fluid 12). The amount of pH adjuster added depends on the desired pH, and the pH adjuster may be added until the desired pH of the pretreatment fluid 12 is achieved.

The co-solvent in the pretreatment fluid 12 may be a water soluble or water miscible co-solvent. Examples of co-solvents include alcohols, amides, esters, ketones, lactones, and ethers. In additional detail, the co-solvent may include aliphatic alcohols, aromatic alcohols, diols, glycol ethers, polyglycol ethers, lactams, caprolactams, formam ides, acetamides, and long chain alcohols. Examples of such compounds include primary aliphatic alcohols, secondary aliphatic alcohols, 1,2-alcohols, 1,3-alcohols, 1,5-alcohols, alkyldiols, ethylene glycol alkyl ethers, propylene glycol alkyl ethers (e.g., DOWANOL™ TPM (from Dow Chemical), higher homologs (C₆-C₁₂) of polyethylene glycol alkyl ethers, N-alkyl caprolactams, unsubstituted caprolactams, both substituted and unsubstituted formam ides, both substituted and unsubstituted acetamides, and the like. Specific examples include ethanol, isopropyl alcohol, butyl alcohol, benzyl alcohol, 2-ethyl-2-(hydroxymethyl)-1,3-propane diol (EPHD), dimethyl sulfoxide, sulfolane, ethylene glycol, diethylene glycol, propylene glycol, butylene glycol, triethylene glycol, 1,5-pentanediol, 1,2-hexanediol, 1,2,6-hexanetriol, glycerin, trimethylolpropane, xylitol. an ethylene oxide adduct of diglycerin, 2-pyrrolidone, 1-(2-hydroxyethyl)-2-pyrrolidone, N-methyl-2-pyrrolidone, cyclohexylpyrrolidone, and triethanolamine.

The co-solvent(s) may be present in the pretreatment fluid 12 in an amount ranging from about 4 wt % active to about 30 wt % active (based on the total weight of the pretreatment fluid 12). In an example, the total amount of co-solvent(s) present in the pretreatment fluid 12 is about 10 wt % active (based on the total weight of the pretreatment fluid 12).

The surfactant in the pretreatment fluid 12 may be any non-ionic surfactant. Examples of the non-ionic surfactant may include polyoxyethylene alkyl ether, polyoxyethylene alkyl phenyl ether, polyoxyethylene fatty acid ester, sorbitan fatty acid ester, polyoxyethylene sorbitan fatty acid ester, polyoxyethylene sorbitol fatty acid ester, glycerin fatty acid ester, polyoxyethylene glycerin fatty acid ester, polyglycerin fatty acid ester, polyoxyethylene alkylamine, polyoxyethylene fatty acid amide, alkylalkanolamide, polyethylene glycol polypropylene glycol block copolymer, acetylene glycol, and a polyoxyethylene adduct of acetylene glycol. Specific examples of the non-ionic surfactant may include polyoxyethylenenonyl phenylether, polyoxyethyleneoctyl phenylether, and polyoxyethylenedodecyl. Further examples of the non-ionic surfactant may include silicon surfactants such as a polysiloxane oxyethylene adduct; fluorine surfactants such as perfluoroalkylcarboxylate, perfluoroalkyl sulfonate, and oxyethyleneperfluoro alkylether; and biosurfactants such as spiculisporic acid, rhamnolipid, and lysolecithin.

More specific examples of suitable non-ionic surfactants include a silicone-free alkoxylated alcohol surfactant such as, for example, TEGO® Wet 510 (Evonik Degussa) and/or a self-emulsifiable wetting agent based on acetylenic diol chemistry, such as, for example, SURFYNOL® SE-F (Evonik Degussa). Other suitable commercially available non-ionic surfactants include SURFYNOL® 465 (ethoxylatedacetylenic diol), SURFYNOL® 440 (an ethoxylated low-foam wetting agent) SURFYNOL® CT-211 (now CARBOWET® GA-211, non-ionic, alkylphenylethoxylate and solvent free), and SURFYNOL® 104 (non-ionic wetting agent based on acetylenic diol chemistry), (all of which are from Evonik Degussa); ZONYL® FSO (a.k.a. CAPSTONE®, which is a water-soluble, ethoxylated non-ionic fluorosurfactant from DuPont); TERGITOL® TMN-3 and TERGITOL® TMN-6 (both of which are branched secondary alcohol ethoxylate, non-ionic surfactants), and TERGITOL® 15-S-3, TERGITOL® 15-S-5, and TERGITOL® 15-S-7 (each of which is a secondary alcohol ethoxylate, non-ionic surfactant) (all of the TERGITOL® surfactants are available from The Dow Chemical Company); and BYK® 345, BYK® 346, BYK® 347, BYK® 348, BYK® 349 (each of which is a silicone surfactant) (all of which are available from BYK).

In any of the examples disclosed herein, the surfactant may be present in the pretreatment fluid 12 in an amount ranging from about 0.01 wt % active to about 5 wt % active (based on the total weight of the pretreatment fluid 12). In an example, the surfactant is present in the pretreatment fluid 12 in an amount ranging from about 0.05 wt % active to about 3 wt % active, based on the total weight of the pretreatment fluid 12. In another example, the surfactant is present in the pretreatment fluid 12 in an amount of about 0.3 wt % active, based on the total weight of the pretreatment fluid 12.

The pretreatment fluid 12 may also include antimicrobial agent(s). Antimicrobial agents are also known as biocides and/or fungicides. Examples of suitable antimicrobial agents include the NUOSEPT® (Ashland Inc.), UCARCIDE™ or KORDEK™ or ROCIMA™ (Dow Chemical Co.), PROXEL® (Arch Chemicals) series, ACTICIDE® B20 and ACTICIDE® M20 and ACTICIDE® MBL (blends of 2-methyl-4-isothiazolin-3-one (MIT), 1,2-benzisothiazolin-3-one (BIT) and Bronopol) (Thor Chemicals), AXIDE™ (Planet Chemical), NIPACIDE™ (Clariant), blends of 5-chloro-2-methyl-4-isothiazolin-3-one (CIT or CMIT) and MIT under the tradename KATHON™ (Dow Chemical Co.), and combinations thereof.

In an example, the total amount of antimicrobial agent(s) in the pretreatment fluid 12 ranges from about 0.01 wt % active to about 0.05 wt % active (based on the total weight of the pretreatment fluid 12). In another example, the total amount of antimicrobial agent(s) in the pretreatment fluid 12 is about 0.044 wt % active (based on the total weight of the pretreatment fluid 12).

In an example, the pretreatment fluid 12 has a viscosity ranging from about 1 cP to about 10 cP at about 25° C. and a shear rate of about 3,000 Hz. The viscosity of the pretreatment fluid 12 may vary depending upon the application method that is to be used to apply the pretreatment fluid 12. When the pretreatment fluid 12 is to be applied with a piezoelectric inkjet applicator/printhead, the viscosity of the pretreatment fluid 12 may range from about 1 cP to about 20 cP (at 20° C. to 25° C. and a shear rate of about 3,000 Hz). When the pretreatment fluid 12 is to be applied with a thermal inkjet applicator/printhead, the pretreatment fluid 12 has a viscosity ranging from about 1 cP to about 10 cP (at 20° C. to 25° C. and a shear rate of about 3,000 Hz).

Fixer Fluid

The fixer fluid 14 includes an azetidinium-containing polyamine and an aqueous vehicle. This aqueous vehicle may be referred to herein as the “second aqueous vehicle” or the “fixer aqueous vehicle.”

In one example, the fixer fluid 14 described herein includes an azetidinium-containing polyamine; a phosphate ester surfactant; a co-solvent containing two hydroxyl groups and an aliphatic chain between the two hydroxyl groups, the aliphatic chain containing three carbon atoms; and a balance of water. In some examples, the fixer fluid 14 consists of the polyamine, the phosphate ester surfactant, the fixer fluid co-solvent, and the balance of water; and thus does not include any other components. In other examples, the azetidinium-containing polyamine further comprises a pH adjuster. In still other examples, the azetidinium-containing polyamine may further include an additional non-ionic surfactant.

The azetidinium-containing polyamine can include any number of azetidinium groups. In an uncrosslinked state, an azetidinium group generally has a structure as follows:

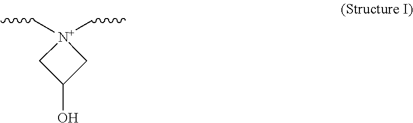

In one example, the azetidinium group is attached to R₁ and NR₂ and thus the azetidinium-containing polyamine includes:

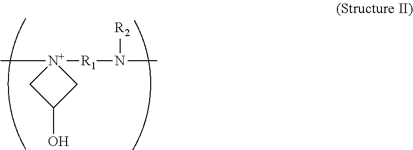

where R₁ can be a substituted or unsubstituted C₂-C₁₂ linear alkyl group and R₂ is H or CH₃. In some additional examples, R₁ can be a C₂-C₁₀, C₂-C₈, or C₂-C₆ linear alkyl group. More generally, there may be from 2 to 12 carbon atoms between amine groups (including azetidinium groups) in the azetidinium-containing polyamine. In other examples, there can be from 2 to 10, from 2 to 8, or from 2 to 6 carbon atoms between amine groups in the azetidinium-containing polyamine. In some examples, where R₁ is a C₃-C₁₂ (or C₃-C₁₀, C₃-C₈, C₃-C₆, etc.) linear alkyl group, a carbon atom along the alkyl chain can be a carbonyl carbon, with the proviso that the carbonyl carbon does not form part of an amide group (i.e., R₁ does not include or form part of an amide group). In some additional examples, a carbon atom of R₁ can include a pendent hydroxyl group.

It is to be understood that Structures I and II are not intended to show repeating units, but rather depict the azetidinium group (Structure I) and the azetidinium group attached to other groups of the polyamine (Structure II). The polyamine can also include various organic groups, polymeric portions, functional moieties, etc. The azetidinium-containing polyamine may have a weight average molecular weight ranging from about 1,000 to 2,000,000, from about 2,000 to about 1,000,000, from about 5,000 to about 200,000, from about 5,000 to about 100,000, or from about 20,000 to about 1,000,000.

In some examples, the azetidinium-containing polyamine can be derived from the reaction of a polyalkylene polyamine (e.g., ethylenediamine, bishexamethylenetriamine, hexamethylenediamine, etc.) with an epihalohydrin (e.g., epichlorohydrin). More particularly, the polyalkylene polyamine reacts with the epihalohydrin to form an epoxide-containing polyamine, which then rearranges by itself to form Structures I or II. These azetidinium-containing polyamines are often referred to as PAmE resins.

As can be seen in Structure II, the azetidinium-containing polyamine can include a quaternary amine (e.g., the azetidinium group) and a non-quaternary amine (e.g., a primary amine, a secondary amine, a tertiary amine, or a combination thereof). In some specific examples, the azetidinium-containing polyamine can include a quaternary amine and a tertiary amine. In some additional examples, the azetidinium-containing polyamine can include a quaternary amine and a secondary amine. In some further examples, the azetidinium-containing polyamine can include a quaternary amine and a primary amine. The azetidinium-containing polyamine can have a ratio of azetidinium groups to other amine groups ranging from 0.1:1 to 10:1. In other examples, the azetidinium-containing polyamine can have a ratio of azetidinium groups to other amine groups ranging from 0.5:1 to 2:1. Some examples of commercially available azetidinium-containing polyamines that fall within these ranges of azetidinium group to amine groups include CREPETROL™ 73, KYMENE™ 736, KYMENE™ 736 NA, POLYCUP™ 7360, and POLYCUP™ 7360 A, each of which is available from Solenis LLC.

The azetidinium-containing polyamine contains a cationic species. When the fixer fluid 14 is printed with the pretreatment fluid 12 disclosed herein, the cationic species of the fixer fluid 14 can interact with the anionic species of the anionically modified cellulose nanocrystals. The interactions of the anionic species (e.g., the sulfonate groups or the carboxylate groups) of the anionically modified cellulose nanocrystals in the pretreatment fluid 12 and cationic species of the azetidinium-containing polyamine of the fixer fluid 14 forms a gel that allows the pigment of the white inkjet ink 16 to be fixed at or near the surface of the textile fabric 18, which improves the opacity of the white image that is formed.

When the pretreatment fluid 12, fixer fluid 14, and white inkjet ink 16 are exposed to curing, the azetidinium group may react with a carboxylate group, a hydroxyl group, an amine group, or a thiol group to open the 4-membered ring adduct of the polyamine. These groups may be present in the pretreatment fluid 12, the white inkjet ink 16, and/or at the surface of the textile fabric 18, and thus cross-linking may occur across different components of the print. The respective reactions between the azetidinium group and each of these groups is illustrated below in Schemes I through IV, as follows:

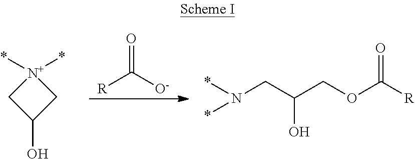

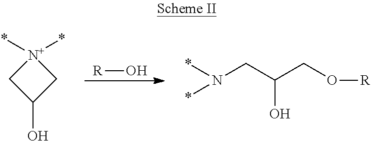

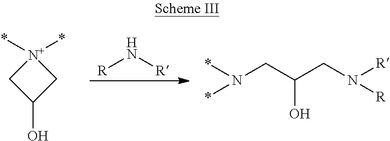

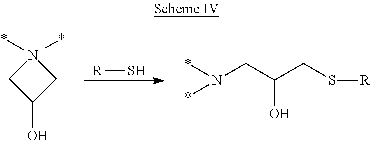

In Schemes I through IV, the asterisks (*) represent portions of the various organic compounds (e.g., a substituted or unsubstituted C₂-C₁₂ linear alkyl group) that may not be directly part of the reaction shown in Scheme I, and are thus not shown, but could be any of a number of organic groups or functional moieties, for example. Likewise, R and R′ can be H or any of a number of organic groups, such as those described previously in connection with R1 or R2 in Structure II, without limitation. These reactions may improve the washfastness of the printed image.

In an example, the azetidinium-containing polyamine is present in the fixer fluid 14 in an amount ranging from about 1 wt % active to about 15 wt % active based on a total weight of the fixer fluid 14. In further examples, the azetidinium-containing polyamine is present in an amount ranging from about 1 wt % active to about 10 wt % active; or from about 2 wt % active to about 8 wt % active; or from about 4 wt % active to about 6.5 wt % active, based on a total weight of the fixer fluid 14.

The fixer fluid 14 also includes a phosphate ester surfactant. The phosphate ester surfactant has the formula:

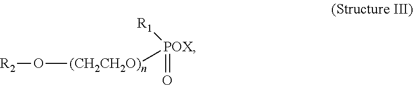

wherein: R₁ is —OX or R₂—O—(CH₂CH₂O)ₙ—, R₂ is an alkyl group, alkenyl group, or alkylphenyl group having from 8 to 18 carbon atoms; X is a hydrogen, alkali metal, amine, or alkanolamine; and n is an integer ranging from 1 to 18. When R₂ is an alkenyl group having from 8 to 18 carbon atoms, it is to be understood that R₂ is a C₈ to C₁₈ alkyl chain that includes one or more alkenyl groups in the chain. Similarly, when R₂ is an alkylphenyl group having from 8 to 18 carbon atoms, it is to be understood that R₂ is a C₈ to C₁₈ alkyl chain that includes one or more alkylphenyl groups as a pendant group attached to the chain. Some examples of commercially available phosphate ester surfactants include CRODAFOS™ 03 A (formerly CRODAFOS™ N3A; a phosphate ester based on tridecyl alcohol), CRODAFOS™ O10A (formerly CRODAFOS™ N10A or CRODAFOS™ N10 Acid; a complex ester of phosphoric acid and ethoxylated oleyl alcohol), and CRODAFOS™ HCE (oleth-5-phosphate and dioleyl phosphate), each of which is available from Croda Int.

While phosphate ester surfactants are often used as anti-kogation agents, it is believed that the combination of the phosphate ester surfactant with the specific fixer fluid co-solvent(s) has a synergistic effect on the kogation reduction.

In an example, the phosphate ester surfactant is present in an amount ranging from about 0.1 wt % active to about 5 wt % active based on a total weight of the fixer composition. In further examples, the phosphate ester surfactant is present in an amount ranging from about 0.5 wt % active to about 3 wt % active; or from about 0.75 wt % active to about 1.5 wt % active; or from about 0.2 wt % active to about 1 wt % active, based on a total weight of the fixer composition.

In one example, the fixer fluid co-solvent contains two hydroxyl groups and an aliphatic chain between the two hydroxyl groups, the aliphatic chain containing three carbon atoms. In one example, the aliphatic chain is not substituted. In this example, the co-solvent is 1,3-propanediol, having the following structure.

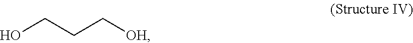

In other examples, the aliphatic chain is substituted, for example, with one or more methyl groups. Examples of the co-solvent with one methyl group include 1,3-butanediol, having the following structure:

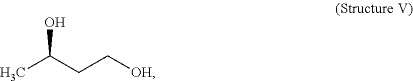

or 2-methyl-1,3-propanediol, having the structure:

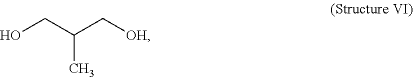

Examples of the fixer fluid co-solvent with two or more methyl group include 2,2-dimethyl-1,3-propanediol, having the structure:

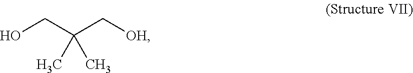

or hexylene glycol, having the following structure.

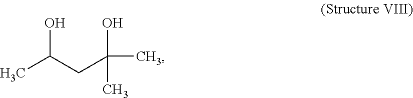

It is believed that alcohols with additional hydroxide groups and/or with longer chain lengths do not lead to the synergistic effect of the co-solvents containing two hydroxyl groups and the C₃ aliphatic chain between the two hydroxyl groups.

In one example of the fixer fluid 14, the co-solvent is selected from the group consisting of 2-methyl-1,3-propanediol, 1,3-butanediol, 1,3-propanediol, hexylene glycol, 2,2-dimethyl-1,3-propanediol, and combinations thereof.

In another example, the fixer fluid co-solvent is an NH-type of N-alkylated lactam, which can help to stabilize the azetidinium-containing polyamine. This stability enhancement can help reduce resin deposit on firing resistors and further improve kogation performance. A few examples of NH-type or N-alkylated lactam co-solvents that can be used in the fixer fluid 14 include γ-lactam co-solvents, δ-lactam co-solvents, ε-lactam co-solvents, and/or β-lactam co-solvents. Structure IX below illustrates various NH-type and N-alkylated lactam co-solvents that may be used:

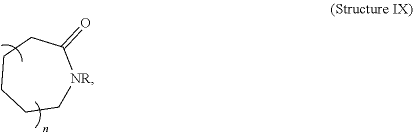

where R is H or a C₁ to C₄ alkyl chain, and n is from 0 to 3, or from 1 to 3. When R is H, the lactam is an NH-type lactam co-solvent. Thus, the term “NH-type” refers to lactam co-solvents where a hydrogen is attached to the nitrogen heteroatom of the lactam ring structure. When R is the C₁ to C₄ alkyl chain (straight chained or branched C₃ or C₄), the lactam is an N-alkylated lactam co-solvent. Thus, the term “N-alkylated” refers to lactam co-solvents where a C₁ to C₄ alkyl group is attached to the nitrogen heteroatom of the lactam ring structure. In further detail, when n is 0, the lactam is a β-lactam co-solvent; when n is 1, the lactam is a γ-lactam co-solvent; when n is 2, the lactam is a δ-lactam, and when n is 3, the lactam is a ε-Lactam co-solvent. Some examples of NH-type lactam co-solvents that can be used include 2-pyrrolidone, 2-piperidinone and caprolactam. Some examples of N-alkylated lactam co-solvents that can be used include N-methyl-2-pyrrolidone, 1-ethyl-2-pyrrolidone, 1-propyl-2-pyrrolidone (branched or straight chained), or 1-butyl-2-pyrrolidone (branched or straight chained).

In an example, the fixer fluid co-solvent is present in an amount ranging from about 1 wt % to about 20 wt % based on a total weight of the fixer fluid 14. Whether used alone or in a combination, the total fixer fluid co-solvent amount is within this range. In further examples, the fixer fluid co-solvent is present in an amount ranging from about 2 wt % to about 15 wt %; or from about 2.5 wt % to about 10 wt %; or from about 3 wt % to about 8 wt %, based on a total weight of the fixer fluid 14.

In addition to the phosphate surfactant and the co-solvent(s), the fixer fluid 14 may further include additional fixer aqueous vehicle components. In some examples, the fixer aqueous vehicle component consists of water. In other examples, the fixer aqueous vehicle component includes additives, such as pH adjuster(s) and other surfactant(s). Each of these additives may be present in an amount of about 0.1 wt % to about 5 wt % based on the total weight of the fixer fluid 14.

The pH adjuster(s) in the fixer fluid 14 may be any example of the pH adjusters set forth herein for the pretreatment fluid 12, in any amount set forth herein for the pretreatment fluid 12 (except that the amount(s) are based on the total weight of the fixer fluid 14 instead of the pretreatment fluid 12). The pH adjuster may be selected to render the fixer fluid 14 with an acidic pH (e.g., 6.5 or less).

The other surfactant(s) in the fixer fluid 14 may be any example of the non-ionic set forth herein for the pretreatment fluid 12, in any amount set forth herein for the pretreatment fluid 12 (except that the amount(s) are based on the total weight of the fixer fluid 14 instead of the pretreatment fluid 12).

In addition to the non-ionic surfactant or as an alternative to the non-ionic surfactant, the fixer fluid 14 may include a cationic surfactant. Examples of the cationic surfactant include quaternary ammonium salts, such as benzalkonium chloride, benzethonium chloride, methylbenzethonium chloride, cetalkonium chloride, cetylpyridinium chloride, cetrimonium, cetrimide, dofanium chloride, tetraethylammonium bromide, didecyldimethylammonium chloride, domiphen bromide, alkylbenzyldimethylammonium chlorides, distearyldimethylammonium chloride, diethyl ester dimethyl ammonium chloride, dipalmitoylethyl hydroxyethylmonium methosulfate, and ACCOSOFT® 808 (methyl (1) tallow amidoethyl (2) tallow imidazolinium methyl sulfate available from Stepan Company). Other examples of the cationic surfactant include amine oxides, such as lauryldimethylamine oxide, myristamine oxide, cocamine oxide, stearamine oxide, and cetamine oxide.

The cationic surfactant may be present in the fixer fluid 14 in an amount ranging from about 0.01 wt % active to about 5 wt % active (based on the total weight of the fixer fluid 14). In an example, the surfactant is present in the fixer fluid 14 in an amount ranging from about 0.05 wt % active to about 3 wt % active, based on the total weight of the fixer fluid 14. In another example, the surfactant is present in the fixer fluid 14 in an amount of about 0.3 wt % active, based on the total weight of the fixer fluid 14.

The balance of the fixer aqueous vehicle is water. As such, the weight percentage of the water present in the fixer fluid 14 will depend, in part, upon the weight percentages of the other components. The water may be purified water or deionized water.

White Inkjet Ink

The white inkjet ink 16 includes a white pigment, a polymeric binder, and an ink vehicle (the latter of which may be referred to herein as the third aqueous vehicle). In some examples, the white inkjet ink 16 consists of the white pigment, the polymeric binder, and the ink vehicle. In other examples, the white inkjet ink 16 may include additional components.

The white pigment may be incorporated into the ink vehicle to form the white inkjet ink 16. The white pigment may be incorporated as a white pigment dispersion. The white pigment dispersion may include a white pigment and a separate pigment dispersant.

For the white pigment dispersions disclosed herein, it is to be understood that the white pigment and separate pigment dispersant (prior to being incorporated into the ink vehicle to form the white inkjet ink 16), may be dispersed in water alone or in combination with an additional water soluble or water miscible co-solvent, such as 2-pyrrolidone, 1-(2-hydroxyethyl)-2-pyrrolidone, glycerol, 2-methyl-1,3-propanediol, 2,2-dimethyl-1,3-propanediol, 1,2-butane diol, diethylene glycol, 1,3-propanediol, 1,4-butanediol, 1,5-pentanediol, triethylene glycol, tetraethylene glycol, hexylene glycol, or a combination thereof. It is to be understood however, that the liquid components of the white pigment dispersion become part of the ink vehicle in the white inkjet ink 16.

Examples of suitable white pigments include white metal oxide pigments, such as titanium dioxide (TiO₂), zinc oxide (ZnO), zirconium dioxide (ZrO₂), or the like. In one example, the white pigment is titanium dioxide. In an example, the titanium dioxide is in its rutile form.

In some examples, the white pigment may include white metal oxide pigment particles coated with silicon dioxide (SiO₂). In one example, the white metal oxide pigment content to silicon dioxide content can be from 100:3.5 to 5:1 by weight. In other examples, the white pigment may include white metal oxide pigment particles coated with silicon dioxide (SiO₂) and aluminum oxide (Al₂O₃). In one example, the white metal oxide pigment content to total silicon dioxide and aluminum oxide content can be from 50:3 to 4:1 by weight. One example of the white pigment includes TI-PURE® R960 (TiO₂ pigment powder with 5.5 wt % silica and 3.3 wt % alumina (based on pigment content)) available from Chemours. Another example of the white pigment includes TI-PURE® R931 (TiO₂ pigment powder with 10.2 wt % silica and 6.4 wt % alumina (based on pigment content)) available from Chemours. Still another example of the white pigment includes TI-PURE® R706 (TiO₂ pigment powder with 3.0 wt % silica and 2.5 wt % alumina (based on pigment content)) available from Chemours.

The white pigment may have high light scattering capabilities, and the average particle size of the white pigment may be selected to enhance light scattering and lower transmittance, thus increasing opacity. The average particle size of the white pigment may range anywhere from about 10 nm to about 2000 nm. In some examples, the average particle size ranges from about 120 nm to about 2000 nm, from about 150 nm to about 1000 nm, from about 150 nm to about 750 nm, or from about 200 nm to about 500 nm. Smaller particles may be desirable depending upon the jetting architecture that is used. The term “average particle size”, as used herein, may refer to a volume-weighted mean diameter of a particle distribution (i.e., mean of a particle size distribution weighted by volume).

The amount of the white pigment in the dispersion may range from about 20 wt % to about 60 wt %, based on the total weight of the dispersion. The white pigment dispersion may then be incorporated into the ink vehicle so that the white pigment is present in an active amount that is suitable for the inkjet printing architecture that is to be used. In an example, the white pigment dispersion is incorporated into the ink vehicle so that the white pigment is present in an amount ranging from about 3 wt % active to about 20 wt % active, based on a total weight of the white inkjet ink 16. In other examples, the white pigment dispersion is incorporated into the ink vehicle so that the white pigment is present in an amount ranging from about 5 wt % active to about 20 wt % active, or from about 5 wt % active to about 15 wt % active, based on a total weight of the white inkjet ink 16. In still another example, the white pigment dispersion is incorporated into the ink vehicle so that the white pigment is present in an amount of about 10 wt % active or about 9.75 wt % active, based on a total weight of the white inkjet ink 16.

The white pigment may be dispersed with the pigment dispersant. In an example, the pigment dispersant is selected from the group consisting of a water-soluble acrylic acid polymer, a branched co-polymer of a comb-type structure with polyether pendant chains and acidic anchor groups attached to a backbone, and a combination thereof.

Some examples of the water-soluble acrylic acid polymer include CARBOSPERSE® K7028 (polyacrylic acid having a weight average molecular weight (Mw) of about 2,300), CARBOSPERSE® K752 (polyacrylic acid having a weight average molecular weight (Mw) of about 2,000), CARBOSPERSE® K7058 (polyacrylic acid having a weight average molecular weight (Mw) of about 7,300), and CARBOSPERSE® K732 (polyacrylic acid having a weight average molecular weight (Mw) of about 6,000), all available from Lubrizol Corporation.

Some examples of the branched co-polymer of the comb-type structure with polyether pendant chains and acidic anchor groups attached to the backbone include DISPERBYK®-190 (an acid number of about 10 mg KOH/g) and DISPERBYK®-199, both available from BYK Additives and Instruments, as well as DISPERSOGEN® PCE available from Clariant.

The amount of the pigment dispersant in the dispersion may range from about 0.1 wt % to about 2 wt %, based on the total weight of the dispersion. The white pigment dispersion may then be incorporated into the ink vehicle so that the pigment dispersant is present in an amount ranging from about 0.01 wt % active to about 0.5 wt % active, based on a total weight of the white inkjet ink 16. In one of these examples, the dispersant is present in an amount of about 0.04 wt % active, based on a total weight of the white inkjet ink 16.

In some examples, the pigment dispersant includes both the water-soluble acrylic acid polymer and the branched co-polymer of the comb-type structure with polyether pendant chains and acidic anchor groups attached to the backbone. In some of these examples, the pigment dispersant includes CARBOSPERSE® K7028 and DISPERBYK®-190. In some of these examples, the pigment dispersant includes both the water-soluble acrylic acid polymer and the branched co-polymer of the comb-type structure with polyether pendant chains and acidic anchor groups attached to the backbone, where the water-soluble acrylic acid polymer is present in an amount ranging from about 0.02 wt % active to about 0.4 wt % active, and the branched co-polymer of the comb-type structure with polyether pendant chains and acidic anchor groups attached to the backbone is present in an amount ranging from about 0.03 wt % active to about 0.6 wt % active. In one of these examples, the water-soluble acrylic acid polymer is present in an amount of about 0.09 wt % active, and the branched co-polymer of the comb-type structure with polyether pendant chains and acidic anchor groups attached to the backbone is present in an amount of about 0.14 wt % active.

The white inkjet ink 16 also includes a polymeric binder, which is one of: a polyurethane-based binder selected from the group consisting of a polyester-polyurethane binder, a polyether-polyurethane binder, a polycarbonate-polyurethane binder, and combinations thereof; or an acrylic latex binder.

In an example, the polymeric binder in the white inkjet ink 16 is a polyurethane-based binder selected from the group consisting of a polyester-polyurethane binder, a polyether-polyurethane binder, a polycarbonate-polyurethane binder, and combinations thereof.

In an example, the white inkjet ink 16 includes the polyester-polyurethane binder. In an example, the polyester-polyurethane binder is an anionic sulfonated polyester-polyurethane binder. The sulfonated polyester-polyurethane binder can include diaminesulfonate groups. In an example, the polyester-polyurethane binder is a sulfonated polyester-polyurethane binder, and is one of: i) an aliphatic compound including multiple saturated C₄ to C₁₀ carbon chains and/or an alicyclic carbon moiety, that is devoid of an aromatic moiety, or ii) an aromatic compound including an aromatic moiety and multiple saturated carbon chain portions ranging from C₄ to C₁₀ in length.

As mentioned, the sulfonated polyester-polyurethane binder can be anionic. In further detail, the sulfonated polyester-polyurethane binder can also be aliphatic, including saturated carbon chains as part of the polymer backbone or as a side-chain thereof, e.g., C₂ to C₁₀, C₃ to C₉, or C₃ to C₆ alkyl. The sulfonated polyester-polyurethane binder can also contain an alicyclic carbon moiety. These polyester-polyurethane binders can be described as “aliphatic” because these carbon chains are saturated and because they are devoid of aromatic moieties. An example of a commercially available anionic aliphatic polyester-polyurethane binder that can be used is IMPRANIL® DLN-SD (Mw 133,000; Acid Number 5.2; Tg −47° C.; Melting Point 175-200° C.) from Covestro. Example components used to prepare the IMPRANIL® DLN-SD or other anionic aliphatic polyester-polyurethane binders suitable for the examples disclosed herein can include pentyl glycols (e.g., neopentyl glycol); C₄ to C₁₀ alkyldiol (e.g., hexane-1,6-diol); C₄ to C₁₀ alkyl dicarboxylic acids (e.g., adipic acid); C₄ to C₁₀ alkyldiamine (e.g., (2, 4, 4)-trimethylhexane-1,6-diamine (TMD), isophorone diamine (IPD)); C₄ to C₁₀ alkyl diisocyanates (e.g., hexamethylene diisocyanate (HDI), (2, 4, 4)-trimethylhexane-1,6-diisocyanate (TMDI)); alicyclic diisocyanates (e.g. isophorone diisocyanate (IPDI), 1,3-bis(isocyanatomethyl)cyclohexane (H6XDI)); diamine sulfonic acids (e.g., 2-[(2-aminoethyl)amino]ethanesulfonic acid); etc.

Alternatively, the sulfonated polyester-polyurethane binder can be aromatic (or include an aromatic moiety) and can include aliphatic chains. An example of an anionic aromatic polyester-polyurethane binder that can be used is DISPERCOLL® U42. Example components used to prepare the DISPERCOLL® U42 or other similar aromatic polyester-polyurethane binders can include aromatic dicarboxylic acids, e.g., phthalic acid; C₄ to C₁₀ alkyl dialcohols (e.g., hexane-1,6-diol); C₄ to C₁₀ alkyl diisocyanates (e.g., hexamethylene diisocyanate (HDI)); diamine sulfonic acids (e.g., 2-[(2-am inoethyl)amino]ethanesulfonic acid); etc.

Other types of anionic polyester-polyurethanes can also be used, including IMPRANIL® DL 1380, which can be somewhat more difficult to jet from thermal inkjet printheads compared to IMPRANIL® DLN-SD and DISPERCOLL® U42, but still can be acceptably jetted in some examples, and can also provide acceptable washfastness results on a variety of fabric types.

The polyester-polyurethane binders disclosed herein may have a weight average molecular weight ranging from about 20,000 to about 300,000. In some examples of the white inkjet ink 16, the polymeric binder is the polyester-polyurethane binder, and the polyester-polyurethane binder has a weight average molecular weight ranging from about 20,000 to about 300,000. As examples, the weight average molecular weight can range from about 50,000 to about 1,000,000, from about 100,000 to about 400,000, or from about 150,000 to about 300,000.

The polyester-polyurethane binders disclosed herein may have an acid number that ranges from about 1 mg KOH/g to about 50 mg KOH/g. In some examples of the white inkjet ink 16, the polymeric binder is the polyester-polyurethane binder, and the polyester-polyurethane binder has an acid number that ranges from about 1 mg KOH/g to about 50 mg KOH/g. As other examples, the acid number of the polyester-polyurethane binder can range from about 1 mg KOH/g to about 200 mg KOH/g, from about 2 mg KOH/g to about 100 mg KOH/g, or from about 3 mg KOH/g to about 50 mg KOH/g.

The average particle size of the polyester-polyurethane binders disclosed herein may range from about 20 nm to about 500 nm. As examples, the sulfonated polyester-polyurethane binder can have an average particle size ranging from about 20 nm to about 500 nm, from about 50 nm to about 350 nm, or from about 100 nm to about 350 nm. The particle size of any solids herein, including the average particle size of the dispersed polymer binder, can be determined using a NANOTRAC® Wave device, from Microtrac, e.g., NANOTRAC® Wave II or NANOTRAC® 150, etc., which measures particles size using dynamic light scattering. Average particle size can be determined using particle size distribution data generated by the NANOTRAC® Wave device. As mentioned, the term “average particle size” may refer to a volume-weighted mean diameter of a particle distribution.

Other examples of the white inkjet ink 16 include an anionic polyether-polyurethane binder. Examples of anionic polyether-polyurethanes that may be used include IMPRANIL® LP DSB 1069, IMPRANIL® DLE, IMPRANIL® DAH, or IMPRANIL® DL 1116 (Covestro (Germany)); or HYDRAN® WLS-201 or HYDRAN® WLS-201K (DIC Corp. (Japan)); or TAKELAC® W-6061T or TAKELAC® WS-6021 (Mitsui (Japan)).

Still other examples of the white inkjet ink 16 include an anionic polycarbonate-polyurethane binder. Examples of anionic polycarbonate-polyurethanes that may be used as the polymeric binder include IMPRANIL® DLC-F or IMPRANIL® DL 2077 (Covestro (Germany)); or HYDRAN® WLS-213 (DIC Corp. (Japan)); or TAKELAC® W-6110 (Mitsui (Japan)).

Examples of non-ionic polyurethane binders include RUCO-PUR® SPH (a hydrophilic, non-ionic polyurethane available from Rudolf Group) and RUCO-COAT® EC 4811 (an aqueous polyurethane/polyether dispersion available from Rudolf Group). Another example of a non-ionic polyurethane binder includes IMPRANIL® DLI (polyether-polyurethane available from Covestro).

Additional examples of the white inkjet ink 16 include an acrylic latex binder. The acrylic latex binder includes latex particles. As used herein, the term “latex” refers to a stable dispersion of polymer particles in an aqueous medium. As such, the polymer (latex) particles may be dispersed in water or water and a suitable co-solvent. This aqueous latex dispersion may be incorporated into a suitable ink vehicle to form examples of the white inkjet ink 16.

The acrylic latex binder may be anionic or non-ionic depending upon the monomers used.

In some examples, the acrylic latex particles can include a polymerization product of monomers including: a copolymerizable surfactant; an aromatic monomer selected from styrene, an aromatic (meth)acrylate monomer, and an aromatic (meth)acrylamide monomer; and multiple aliphatic (meth)acrylate monomers or multiple aliphatic (meth)acrylamide monomers. The term “(meth)” indicates that the acrylamide, the acrylate, etc., may or may not include the methyl group. In one example, the latex particles can include a polymerization product of a copolymerizable surfactant such as HITENOL™ BC-10, BC-30, KH-05, or KH-10. In another example, the latex particles can include a polymerization product of styrene, methyl methacrylate, butyl acrylate, and methacrylic acid.

In another particular example, the latex particles can include a first heteropolymer phase and a second heteropolymer phase. The first heteropolymer phase is a polymerization product of multiple aliphatic (meth)acrylate monomers or multiple aliphatic (meth)acrylamide monomers. The second heteropolymer phase can be a polymerization product of an aromatic monomer with a cycloaliphatic monomer, wherein the aromatic monomer is an aromatic (meth)acrylate monomer or an aromatic (meth)acrylamide monomer, and wherein the cycloaliphatic monomer is a cycloaliphatic (meth)acrylate monomer or a cycloaliphatic (meth)acrylamide monomer. The second heteropolymer phase can have a higher glass transition temperature than the first heteropolymer phase. The first heteropolymer composition may be considered a soft polymer composition and the second heteropolymers composition may be considered a hard polymer composition.

The two phases can be physically separated in the latex particles, such as in a core-shell configuration, a two-hemisphere configuration, smaller spheres of one phase distributed in a larger sphere of the other phase, interlocking strands of the two phases, and so on.

The first heteropolymer composition can be present in the latex particles in an amount ranging from about 15 wt % to about 70 wt % of a total weight of the polymer (latex) particle and the second heteropolymer composition can be present in an amount ranging from about 30 wt % to about 85 wt % of the total weight of the polymer particle. In other examples, the first heteropolymer composition can be present in an amount ranging from about 30 wt % to about 40 wt % of a total weight of the polymer particle and the second heteropolymer composition can be present in an amount ranging from about 60 wt % to about 70 wt % of the total weight of the polymer particle. In one specific example, the first heteropolymer composition can be present in an amount of about 35 wt % of a total weight of the polymer particle and the second heteropolymers composition can be present in an amount of about 65 wt % of the total weight of the polymer particle.

As mentioned herein, the first heteropolymer phase can be polymerized from two or more aliphatic (meth)acrylate ester monomers or two or more aliphatic (meth)acrylamide monomers. The aliphatic (meth)acrylate ester monomers may be linear aliphatic (meth)acrylate ester monomers and/or cycloaliphatic (meth)acrylate ester monomers. Examples of the linear aliphatic (meth)acrylate ester monomers can include ethyl acrylate, ethyl methacrylate, benzyl acrylate, benzyl methacrylate, propyl acrylate, propyl methacrylate, isopropyl acrylate, isopropyl methacrylate, butyl acrylate, butyl methacrylate, isobutyl acrylate, isobutyl methacrylate, hexyl acrylate, hexyl methacrylate, isooctyl acrylate, isooctyl methacrylate, octadecyl acrylate, octadecyl methacrylate, lauryl acrylate, lauryl methacrylate, hydroxyethyl acrylate, hydroxyethyl methacrylate, hydroxyhexyl acrylate, hydroxyhexyl methacrylate, hydroxyoctadecyl acrylate, hydroxyoctadecyl methacrylate, hydroxylauryl methacrylate, hydroxylauryl acrylate, 2-ethylhexyl acrylate, 2-ethylhexyl methacrylate, and combinations thereof. Examples of the cycloaliphatic (meth)acrylate ester monomers can include cyclohexyl acrylate, cyclohexyl methacrylate, methylcyclohexyl acrylate, methylcyclohexyl methacrylate, trimethylcyclohexyl acrylate, trimethylcyclohexyl methacrylate, tert-butylcyclohexyl acrylate, tert-butylcyclohexyl methacrylate, and combinations thereof.

Also as mentioned herein, the second heteropolymer phase can be polymerized from a cycloaliphatic monomer and an aromatic monomer. The cycloaliphatic monomer can be a cycloaliphatic (meth)acrylate monomer or a cycloaliphatic (meth)acrylamide monomer. The aromatic monomer can be an aromatic (meth)acrylate monomer or an aromatic (meth)acrylamide monomer. The cycloaliphatic monomer of the second heteropolymer phase can be cyclohexyl acrylate, cyclohexyl methacrylate, methylcyclohexyl acrylate, methylcyclohexyl methacrylate, trimethylcyclohexyl acrylate, trimethylcyclohexyl methacrylate, tert-butylcyclohexyl acrylate, tert-butylcyclohexyl methacrylate, or a combination thereof. In still further examples, the aromatic monomer of the second heteropolymer phase can be 2-phenoxyethyl methacrylate, 2-phenoxyethyl acrylate, phenyl propyl methacrylate, phenyl propyl acrylate, benzyl methacrylate, benzyl acrylate, phenylethyl methacrylate, phenylethyl acrylate, benzhydryl methacrylate, benzhydryl acrylate, 2-hydroxy-3-phenoxypropyl acrylate, 2-hydroxy-3-phenoxypropyl methacrylate, N-benzyl methacrylamide, N-benzyl acrylamide, N,N-diphenyl methacrylamide, N,N-diphenyl acrylamide, naphthyl methacrylate, naphthyl acrylate, phenyl methacrylate, phenyl acrylate, or a combination thereof.

The latex particles can have an average particle size ranging from 20 nm to 500 nm, from 50 nm to 350 nm, or from 150 nm to 270 nm.

In some examples, the latex particles can be prepared by flowing multiple monomer streams into a reactor. An initiator can also be included in the reactor. The initiator may be selected from a persulfate, such as a metal persulfate or an ammonium persulfate. In some examples, the initiator may be selected from a sodium persulfate, ammonium persulfate or potassium persulfate. The preparation process may be performed in water, resulting in the aqueous latex dispersion.

Examples of anionic acrylic latex binders include JANTEX™ Binder 924 and JANTEX™ Binder 45 NRF (both of which are available from Jantex). Other examples of anionic acrylic latex binders include TEXICRYL™ 13-216, TEXICRYL™13-217, TEXICRYL™13-220, TEXICRYL™13-294, TEXICRYL™13-295, TEXICRYL™13-503, and TEXICRYL™13-813 (each of which is available from Scott Bader). Still other examples of anionic acrylic latex binders include TUBIFAST™ AS 4010 FF, TUBIFAST™ AS 4510 FF, and TUBIFAST™ AS 5087 FF (each of which is available from CHT).

Examples of non-ionic acrylic latex binders include PRINTRITE™ 595, PRINTRITE™ 2015, PRINTRITE™ 2514, PRINTRITE™ 9691, and PRINTRITE™ 96155 (each of which is available from Lubrizol Corporation). Another example of a non-ionic acrylic latex binder includes TEXICRYL™ 13-440 (available from Scott Bader).

In some examples of the white inkjet ink 16, the polymeric binder is present in an amount ranging from about 1 wt % active to about 20 wt % active, based on a total weight of the white inkjet ink 16. In other examples, the polymeric binder can be present, in the white inkjet ink 16, in an amount ranging from about 2 wt % active to about 15 wt % active, or from about from about 3 wt % active to about 11 wt % active, or from about 4 wt % active to about 10 wt % active, or from about 5 wt % active to about 9 wt % active, each of which is based on the total weight of the white inkjet ink 16.

The polymeric binder (prior to being incorporated into the ink vehicle) may be dispersed in water alone or in combination with an additional water soluble or water miscible co-solvent, such as 2-pyrrolidone, 1-(2-hydroxyethyl)-2-pyrrolidone, glycerol, 2-methyl-1,3-propanediol, 1,2-butane diol, diethylene glycol, triethylene glycol, tetraethylene glycol, or a combination thereof. It is to be understood however, that the liquid components of the binder dispersion become part of the vehicle in the white inkjet ink 16.

In addition to the pigment and the polymeric binder, the white inkjet ink 16 includes an ink vehicle.

As used herein, the terms “ink vehicle” and “third aqueous vehicle” may refer to the liquid with which the pigment (dispersion) and polymeric binder (dispersion) are mixed to form a thermal or a piezoelectric inkjet ink(s) composition. A wide variety of vehicles may be used with the ink composition(s) of the present disclosure. The ink vehicle may include water and any of: a co-solvent, a surfactant, an anti-kogation agent, an anti-decel agent, an antimicrobial agent, a rheology modifier, a pH adjuster, or combinations thereof. In an example of the white inkjet ink 16, the vehicle includes water and a co-solvent. In another example of the white inkjet ink 16, the vehicle consists of water and the co-solvent, the anti-kogation agent, the anti-decel agent, the surfactant, the antimicrobial agent, a rheology modifier, a pH adjuster, or a combination thereof. In still another example, the ink vehicle consists of the anti-kogation agent, the anti-decel agent, the surfactant, the antimicrobial agent, a rheology modifier, a pH adjuster, and water.

The co-solvent in the white inkjet ink 16 may be any example of the co-solvents set forth herein for the pretreatment fluid 12 or fixer fluid 14, in any amount set forth herein for the pretreatment fluid 12 or fixer fluid 14 (except that the amount(s) are based on the total weight of the white inkjet ink 16 instead of pretreatment fluid 12 or the fixer fluid 14).

The surfactant in the white inkjet ink 16 may be any anionic and/or non-ionic surfactant.

Examples of the anionic surfactant may include alkylbenzene sulfonate, alkylphenyl sulfonate, alkylnaphthalene sulfonate, higher fatty acid salt, sulfate ester salt of higher fatty acid ester, sulfonate of higher fatty acid ester, sulfate ester salt and sulfonate of higher alcohol ether, higher alkyl sulfosuccinate, polyoxyethylene alkylether carboxylate, polyoxyethylene alkylether sulfate, alkyl phosphate, and polyoxyethylene alkyl ether phosphate. Specific examples of the anionic surfactant may include dodecylbenzenesulfonate, isopropylnaphthalenesulfonate, monobutylphenylphenol monosulfonate, monobutylbiphenyl sulfonate, monobutylbiphenylsul fonate, and dibutylphenylphenol disulfonate.

Any example of the non-ionic surfactants set forth herein for the pretreatment fluid 12 or the fixer fluid 14 may be used in the white inkjet ink 16.

Furthermore, the anionic and/or non-ionic surfactant may be included in the white inkjet ink 16 in any amount set forth herein for the surfactant in the pretreatment fluid 12 or the fixer fluid 14 (except that the amount(s) are based on the total weight of the white inkjet ink 16 instead of the pretreatment fluid 12 or the fixer fluid 14).

An anti-kogation agent may also be included in the vehicle of the white inkjet ink 16, for example, when the white inkjet ink 16 is to be applied via a thermal inkjet printhead. An anti-kogation agent(s) is/are included to assist in preventing the buildup of kogation. In some examples, the anti-kogation agent may improve the jettability of the white inkjet ink 16.

Examples of suitable anti-kogation agents include oleth-3-phosphate (commercially available as CRODAFOS™ 03 A or CRODAFOS™ N-3A) or dextran 500 k. Other suitable examples of the anti-kogation agents include CRODAFOS™ HCE (phosphate-ester from Croda Int.), CRODAFOS® 010A (oleth-10-phosphate from Croda Int.), or DISPERSOGEN® LFH (polymeric dispersing agent with aromatic anchoring groups, acid form, anionic, from Clariant), etc. It is to be understood that any combination of the anti-kogation agents listed may be used.

The anti-kogation agent may be present in the white inkjet ink 16 in an amount ranging from about 0.1 wt % active to about 1.5 wt % active, based on the total weight of the white inkjet ink 16. In an example, the anti-kogation agent is present in an amount of about 0.5 wt % active, based on the total weight of the white inkjet ink 16.

The ink vehicle may also include anti-decel agent(s). The anti-decel agent may function as a humectant. Decel refers to a decrease in drop velocity over time with continuous firing. In the examples disclosed herein, the anti-decel agent(s) is/are included to assist in preventing decel. In some examples, the anti-decel agent may improve the jettability of the white inkjet ink 16. An example of a suitable anti-decel agent is ethoxylated glycerin having the following formula:

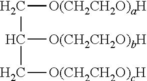

in which the total of a+b+c ranges from about 5 to about 60, or in other examples, from about 20 to about 30. An example of the ethoxylated glycerin is LIPONIC® EG-1 (LEG-1, glycereth-26, a+b+c=26, available from Lipo Chemicals).

The anti-decel agent(s) may be present in an amount ranging from about 0.2 wt % active to about 5 wt % active (based on the total weight of the white inkjet ink 16). In an example, the anti-decel agent is present in the white inkjet ink 16 in an amount of about 1 wt % active, based on the total weight of the white inkjet ink 16.

The vehicle of the white inkjet ink 16 may also include antimicrobial agent(s). Any of the antimicrobial agents are set forth herein may be used. In an example, the total amount of antimicrobial agent(s) in the white inkjet ink 16 ranges from about 0.01 wt % active to about 0.05 wt % active (based on the total weight of the white inkjet ink 16). In another example, the total amount of antimicrobial agent(s) in the white inkjet ink 16 is about 0.044 wt % active (based on the total weight of the white inkjet ink 16).

The ink vehicle may also include rheology additive(s). The rheology additive may be added to adjust the viscosity of the white inkjet ink 16 and to aid in redispersibility of the white inkjet ink after it has sat idle. Examples of suitable rheology additives include boehmite, anionic cellulose (e.g., carboxymethyl cellulose, cellulose sulfate, nitrocellulose, and combinations thereof), and combinations thereof.

In an example, the total amount of rheology additive(s) in the white inkjet ink 16 ranges from about 0.005 wt % active to about 5 wt % active (based on the total weight of the white inkjet ink 16).

The ink vehicle of the white inkjet ink 16 may also include a pH adjuster. A pH adjuster may be included in the white inkjet ink 16 to achieve a desired pH of greater than 7. Suitable pH ranges for examples of the ink composition can be from greater than 7 to about 11, from greater than 7 to about 10, from about 7.2 to about 10, from about 7.5 to about 10, from about 8 to about 10, from about 7 to about 9, from about 7.2 to about 9, from about 7.5 to about 9, from about 8 to about 9, from about 7 to about 8.5, from about 7.2 to about 8.5, from about 7.5 to about 8.5, from about 8 to about 8.5, from about 7 to about 8, from about 7.2 to about 8, or from about 7.5 to about 8.

The type and amount of pH adjuster that is added may depend upon the initial pH of the white inkjet ink 16 and the desired final pH of the white inkjet ink 16. If the initial pH is too high, an acid may be added to lower the pH, and if the initial pH is too low, a base may be added increase the pH. Examples of suitable pH adjusters include metal hydroxide bases, such as potassium hydroxide (KOH), sodium hydroxide (NaOH), etc. In an example, the metal hydroxide base may be added to the while inkjet ink 16 in an aqueous solution. In another example, the metal hydroxide base may be added to the white inkjet ink 16 in an aqueous solution including 5 wt % of the metal hydroxide base (e.g., a 5 wt % potassium hydroxide aqueous solution). Any of the acidic pH adjusters mentioned herein may also be used.

In an example, the total amount of pH adjuster(s) in the white inkjet ink 16 ranges from greater than 0 wt % to about 0.1 wt % (based on the total weight of the white inkjet ink 16). In another example, the total amount of pH adjuster(s) in the white inkjet ink 16 is about 0.03 wt % (based on the total weight of the white inkjet ink 16).

The balance of the white inkjet ink 16 is water. In an example, purified water or deionized water may be used. The water included in the white inkjet ink 16 may be: i) part of the pigment dispersion, and/or binder dispersion, ii) part of the ink vehicle, iii) added to a mixture of the pigment dispersion, and/or binder dispersion and the ink vehicle, or iv) a combination thereof. In examples where the white inkjet ink 16 is a thermal inkjet ink, the ink vehicle includes at least 70% by weight of water. In examples where the ink composition is a piezoelectric inkjet ink, the liquid vehicle is a solvent based vehicle including at least 50% by weight of the co-solvent.

One specific example of the white inkjet ink 16 includes the pigment in an amount ranging from about 1 wt % active to about 10 wt % active based on the total weight of the white inkjet ink 16; the polymeric binder in an amount ranging from about 2 wt % active to about 10 wt % active of the total weight of the white inkjet ink 16; an additive selected from the group consisting of a non-ionic surfactant, an antimicrobial agent, an anti-decel agent, a rheology modifier, and combinations thereof; and the liquid vehicle, which includes water and an organic solvent (e.g., the co-solvent disclosed herein).

Examples of the white inkjet ink 16 disclosed herein may be used in a thermal inkjet printer or in a piezoelectric printer. The viscosity of the white inkjet ink 16 may be adjusted for the type of printhead by adjusting the co-solvent level, adjusting the polymeric binder level, and/or adding a viscosity modifier. When used in a thermal inkjet printer, the viscosity of the white inkjet ink 16 may be modified to range from about 1 cP to about 9 cP (at 20° C. to 25° C. measured at a shear rate of about 3,000 Hz). When used in a piezoelectric printer, the viscosity of the white inkjet ink 16 may be modified to range from about 1 cP to about 20 cP (at 20° C. to 25° C. measured at a shear rate of about 3,000 Hz), depending on the type of the printhead that is being used (e.g., low viscosity printheads, medium viscosity printheads, or high viscosity printheads).

Textile Fabrics

In the examples disclosed herein, the textile fabric 18 may be selected from the group consisting of polyester fabrics, polyester blend fabrics, cotton fabrics, cotton blend fabrics, nylon fabrics, nylon blend fabrics, silk fabrics, silk blend fabrics, wool fabrics, wool blend fabrics, and combinations thereof. In a further example, the textile fabric 18 is selected from the group consisting of cotton fabrics and cotton blend fabrics.

It is to be understood that organic textile fabrics and/or inorganic textile fabrics may be used for the textile fabric 18. Some types of fabrics that can be used include various fabrics of natural and/or synthetic fibers. It is to be understood that the polyester fabrics may be a polyester coated surface. The polyester blend fabrics may be blends of polyester and other materials (e.g., cotton, linen, etc.). In another example, the textile fabric 18 may be selected from nylons (polyam ides) or other synthetic fabrics.

Example natural fiber fabrics that can be used include treated or untreated natural fabric textile substrates, e.g., wool, cotton, silk, linen, jute, flax, hemp, rayon fibers, thermoplastic aliphatic polymeric fibers derived from renewable resources (e.g. cornstarch, tapioca products, sugarcanes), etc. Example synthetic fibers used in the textile fabric/substrate 18 can include polymeric fibers such as nylon fibers, polyvinyl chloride (PVC) fibers, PVC-free fibers made of polyester, polyamide, polyimide, polyacrylic, polypropylene, polyethylene, polyurethane, polystyrene, polyaramid (e.g., KEVLAR®) polytetrafluoroethylene (TEFLON®) (both trademarks of E.I. du Pont de Nemours and Company, Delaware), fiberglass, polytrimethylene, polycarbonate, polyethylene terephthalate, polyester terephthalate, polybutylene terephthalate, or a combination thereof. In an example, natural and synthetic fibers may be combined at ratios of 1:1, 1:2, 1:3, 1:4, 1:5, 1:6, 1:7, 1:8, 1:9, 1:10, 1:11, 1:12, 1:13, 1:14, 1:15, 1:16, 1:17, 1:18, 1:19, 1:20, or vice versa. In some examples, the fiber can be a modified fiber from the above-listed polymers. The term “modified fiber” refers to one or both of the polymeric fiber and the fabric as a whole having undergone a chemical or physical process such as, but not limited to, copolymerization with monomers of other polymers, a chemical grafting reaction to contact a chemical functional group with one or both the polymeric fiber and a surface of the fabric, a plasma treatment, a solvent treatment, acid etching, or a biological treatment, an enzyme treatment, or antimicrobial treatment to prevent biological degradation.

In addition, the textile fabric 18 can contain additives, such as a colorant (e.g., pigments, dyes, and tints), an antistatic agent, a brightening agent, a nucleating agent, an antioxidant, a UV stabilizer, a filler, and/or a lubricant, for example.

It is to be understood that the terms “textile fabric” or “fabric substrate” do not include materials commonly known as any kind of paper (even though paper can include multiple types of natural and synthetic fibers or mixtures of both types of fibers). Fabric substrates can include textiles in filament form, textiles in the form of fabric material, or textiles in the form of fabric that has been crafted into finished articles (e.g., clothing, blankets, tablecloths, napkins, towels, bedding material, curtains, carpet, handbags, shoes, banners, signs, flags, etc.). In some examples, the fabric substrate can have a woven, knitted, non-woven, or tufted fabric structure. In one example, the fabric substrate can be a woven fabric where warp yarns and weft yarns can be mutually positioned at an angle of about 90°. This woven fabric can include fabric with a plain weave structure, fabric with twill weave structure where the twill weave produces diagonal lines on a face of the fabric, or a satin weave. In another example, the fabric substrate can be a knitted fabric with a loop structure. The loop structure can be a warp-knit fabric, a weft-knit fabric, or a combination thereof. A warp-knit fabric refers to every loop in a fabric structure that can be formed from a separate yarn mainly introduced in a longitudinal fabric direction. A weft-knit fabric refers to loops of one row of fabric that can be formed from the same yarn. In a further example, the fabric substrate can be a non-woven fabric. For example, the non-woven fabric can be a flexible fabric that can include a plurality of fibers or filaments that are one or both bonded together and interlocked together by a chemical treatment process (e.g., a solvent treatment), a mechanical treatment process (e.g., embossing), a thermal treatment process, or a combination of multiple processes.

In one example, the textile fabric 18 can have a basis weight ranging from 10 gsm to 500 gsm. In another example, the textile fabric 18 can have a basis weight ranging from 50 gsm to 400 gsm. In other examples, the textile fabric 18 can have a basis weight ranging from 100 gsm to 300 gsm, from 75 gsm to 250 gsm, from 125 gsm to 300 gsm, or from 150 gsm to 350 gsm.

The textile fabric 18 may be any color, and in an example is a color other than white (e.g., black, grey, etc.).

Printing Method and System

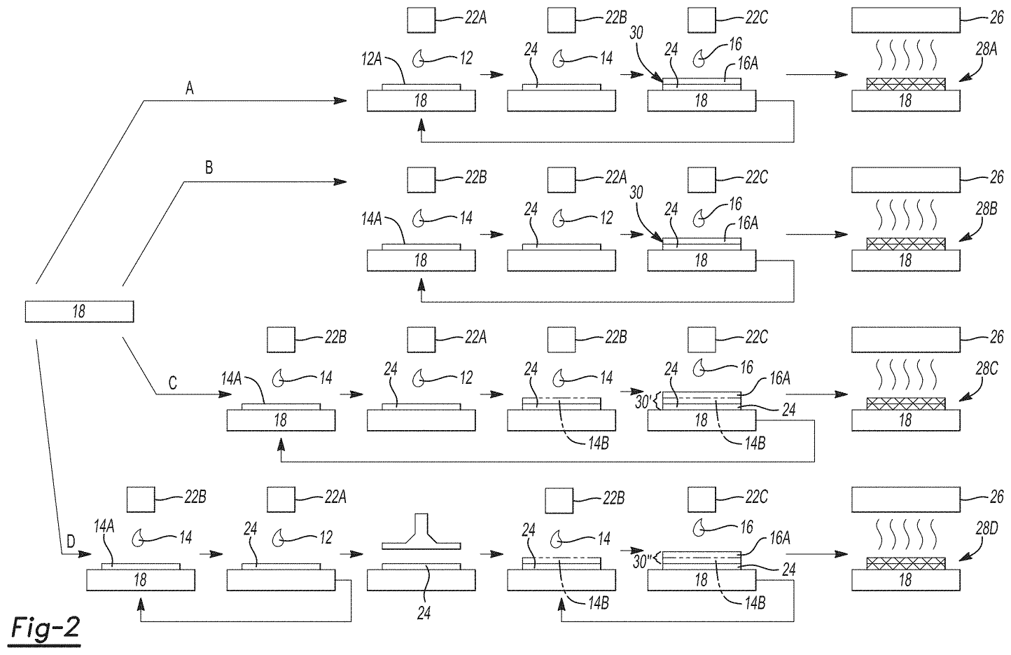

An example of a printing method comprises: forming a gel on a textile fabric 18 by: inkjet printing a pretreatment fluid 12 on an area of the textile fabric 18, the pretreatment fluid 12 including anionically modified cellulose nanocrystals and a first aqueous vehicle; inkjet printing a fixer fluid 14 on the area of the textile fabric 18; inkjet printing a white inkjet ink 16 on the gel on the textile fabric 18; and thermally curing the textile fabric 18 having the gel and the white inkjet ink 16 thereon, thereby generating a print. A more specific example of the printing method comprises: forming a gel on a textile fabric 18 by: inkjet printing a pretreatment fluid 12 on an area of the textile fabric 18, the pretreatment fluid 12 including anionically modified cellulose nanocrystals and a first aqueous vehicle; inkjet printing a fixer fluid 14 on the area of the textile fabric 18, the fixer fluid 14 including an azetidinium-containing polyamine and a second aqueous vehicle; inkjet printing a white inkjet ink 16 on the gel on the textile fabric 18; and thermally curing the textile fabric 18 having the gel and the white inkjet ink 16 thereon, thereby generating a print. FIG. 2 depicts examples of various printing modes (e.g., routes A, B, C, and D) that may be used in the printing method.

It is to be understood that any example of the pretreatment fluid 12, the fixer fluid 14, and the white inkjet ink 16 may be used in the examples of the method. Further, it is to be understood that any example of the textile fabric 18 may be used in the examples of the method.

Examples of the method include inkjet printing the pretreatment fluid 12 on the textile fabric 18 and the fixer fluid 14 on the textile fabric 18 at ambient temperature. In other words, the textile fabric 18 is maintained at a temperature ranging from about 18° C. to about 25° C. during printing. The gel film 24 is formed when the pretreatment fluid 12 and the fixer fluid 14 come in contact with each other on the textile fabric 18.

The pretreatment fluid 12 is applied to the textile fabric 18, either directly or indirectly. When directly applied, the pretreatment fluid 12 is the first of the fluids that is applied to the textile fabric 18. When indirectly applied, the fixer fluid 14 is applied prior to the pretreatment fluid 12. The application of the pretreatment fluid 12 may be accomplished via piezoelectric inkjet printing, or via thermal inkjet printing.

The fixer fluid 14 is applied to the textile fabric 18, either directly or indirectly. When directly applied, the fixer fluid 14 is the first of the fluids that is applied to the textile fabric 18. When indirectly applied, the pretreatment fluid 12 is applied prior to the fixer fluid 14. The application of the fixer fluid 14 may be accomplished via piezoelectric inkjet printing, or via thermal inkjet printing.

The pretreatment fluid 12 and the fixer fluid 14 form a gel 24. In some examples, forming the gel 24 involves i) inkjet printing the pretreatment fluid 12 directly on the area of the textile fabric 18; and inkjet printing the fixer fluid 14 on the pretreatment fluid 12; or ii) inkjet printing the fixer fluid 14 directly on the area of the textile fabric 18; and inkjet printing the pretreatment fluid 12 on the fixer fluid 14.

The white inkjet ink 16 is applied to the textile fabric 18 after the application of each of the pretreatment fluid 12 and the fixer fluid 14. The application of the white inkjet ink 16 may be accomplished via piezoelectric inkjet printing, or via thermal inkjet printing.

Because inkjet printing is used, the pretreatment fluid 12, the fixer fluid 14, and the white inkjet ink 16 may be selectively applied to the textile fabric 18. The pretreatment fluid 12, the fixer fluid 14, and the white inkjet ink 16 may be applied on areas of the textile fabric 18 where it is desirable to form the print 28A, 28B, 28C, 28D. In these examples, area(s) of the textile fabric 18 where it is not desirable to form the print 28A, 28B, 28C, 28D may remain exposed (i.e., not have any of the fluids 12, 14, 16, applied thereon).

The various fluids may be applied in multiple passes, and thus the following amounts encompass the total amount of the individual fluid 12, 14, 16 that is applied to form the print 28A, 28B, 28C, 28D. In an example, the pretreatment fluid 12 is applied in an amount ranging from about 30 gsm (grams per square meter, when wet) to about 200 gsm. In another example, the pretreatment fluid 12 is applied in an amount ranging from about 85 gsm to about 100 gsm. The amount of fixer fluid 14 that is applied depends upon the amount of white inkjet ink 16 that is to be applied. In some examples, the fixer fluid 14 is applied in an amount ranging from about 10 gsm to about 100 gsm. In other examples, the fixer fluid 14 is applied in an amount ranging from about 15 gsm to about 60 gsm. The white inkjet ink 16 is applied in an amount ranging from about 40 gsm to about 400 gsm. In another example, the white inkjet ink 16 is applied in an amount ranging from about 45 gsm to about 200 gsm.

Referring now to FIG. 2, several example printing modes of the method are depicted. Each printing mode is identified as an individual route, including route A, route B, route C, and route D. The printing method involves the formation of a gel on the textile fabric 18, and the various routes A, B, C, D depict a variety of ways to generate the gel, and the final print 28A, 28B, 28C, 28D.

In some examples, forming the gel involves inkjet printing the pretreatment fluid 12 directly on the area of the textile fabric 18, and inkjet printing the fixer fluid 14 on the pretreatment fluid 12 (route A). In other examples, forming the gel involves inkjet printing the fixer fluid 14 directly on the area of the textile fabric 18; and inkjet printing the pretreatment fluid 12 on the fixer fluid 14 (route B).

Referring specifically to route A, an applicator 22A is used to inkjet print the pretreatment fluid 12 on a desired area of the textile fabric 18. The applicator 22A (and any of the applicators 22B, 22C disclosed herein) may be a thermal inkjet applicator or a piezoelectric inkjet applicator. The inkjet applicator may be a cartridge or pen including, e.g., a reservoir, a droplet generator (e.g., resistor, piezoelectric actuator), and a plurality of nozzles.

As shown in route A, a layer 12A of the pretreatment fluid 12 is deposited on the desired area of the textile fabric 18. Then, the fixer fluid 14 is deposited on the layer 12A to form the gel 24. The pretreatment fluid 12 and the fixer fluid 14 are applied sequentially, one immediately after the other as the applicators 22A, 22B pass over the textile fabric 18. As such, the fixer fluid 14 is printed onto the pretreatment fluid 12 while the pretreatment fluid 12 is wet. Wet-on-wet printing is desirable in the examples disclosed herein so that the fluids 12, 14 intermingle to form the gel 24, and because the printing workflow is simplified without the additional drying. In an example of wet-on-wet printing, the fixer fluid 14 is printed onto the pretreatment fluid 12 within a period of time ranging from about 0.01 second to about 30 seconds after the pretreatment fluid 12 is printed. Wet-on-wet printing may be accomplished in a single pass.

Once the gel 24 is formed, the white inkjet ink 16 is deposited on the gel 24. The deposited white inkjet ink 16 forms an ink layer 16A on the gel 24. The combination of the gel 24 and the ink layer 16A forms a stack 30. The gel 24 forms a film that blocks pores of the textile fabric 18, and thus the pigment of the ink layer 16A is located at or near the surface of the textile fabric 18, which ultimately contributes to improved opacity of the white image 28A that is formed.

The processes involved in forming the stack 30 may be repeated as many times as desired to create multiple stacks 30 on the textile fabric 18. Multiple stacks 30 may contribute to increased opacity. To form a second stack on the first stack 30, the pretreatment fluid 12 is inkjet printed onto the stack 30, the fixer fluid 14 is inkjet printed onto the additional layer of pretreatment fluid 12 to form a second layer of gel, and the white inkjet ink 16 is inkjet printed onto the second layer of gel. It is to be understood that any desired number of stacks 30 may be generated, and in one example, the process is repeated six times to generate six stacks 30 on the textile fabric 18.

Once a desired number of stacks 30 is formed, the example shown in route A then involves thermally curing the textile fabric 18 having the stack(s) 30 thereon. This generates the white print 28A (shown in FIG. 2, route A). The thermal curing may be accomplished by applying heat to the textile fabric 18. Heating may be performed using any suitable heating mechanism 26, such as a heat press, oven, etc., that is capable of convection heating, air-draft, radiant hear, infrared heating, etc. The heat generated is sufficient to initiate crosslinking or other interactions that bind the pigment onto the textile fabric 18. In an example, the thermal curing the textile fabric 18 (having the stack(s) 30 thereon) involves heating at a temperature ranging from about 80° C. to about 200° C. for a time ranging from about 5 seconds to about 10 minutes. In another example, the temperature ranges from about 100° C. to about 180° C. In still another example, thermal curing is achieved by heating the textile fabric 18 to a temperature of 150° C. for about 3 minutes.

Pressure may also be applied during thermal curing. The pressure applied to the textile fabric 18 (with the stack(s) 30 thereon) ranges from about 0.1 atm to about 8 atm.

In the example printing mode of route B, forming the gel involves inkjet printing the fixer fluid 14 on the area (of the textile fabric 18); and then inkjet printing the pretreatment fluid 12 on the area (where the fixer fluid 14 has been applied).

Referring specifically to route B, an applicator 22B is used to inkjet print the fixer fluid 14 on a desired area of the textile fabric 18. As shown in route B, a layer 14A of the fixer fluid 14 is deposited on the desired area of the textile fabric 18. Then, the pretreatment fluid 12 is deposited on the layer 14A to form the gel 24. The fixer fluid 14 and the pretreatment fluid 12 are applied sequentially, one immediately after the other as the applicators 22B, 22A pass over the textile fabric 18. As such, the pretreatment fluid 12 is printed onto the fixer fluid 14 while the fixer fluid 14 is wet. Wet-on-wet printing is desirable in the examples disclosed herein so that the fluids 14, 12 intermingle to form the gel 24, and because the printing workflow is simplified without the additional drying. In an example of wet-on-wet printing, the pretreatment fluid 12 is printed onto the fixer fluid 14 within a period of time ranging from about 0.01 second to about 30 seconds after the fixer fluid 14 is printed. Wet-on-wet printing may be accomplished in a single pass.

Once the gel 24 is formed, the white inkjet ink 16 is deposited on the gel 24. The deposited white inkjet ink 16 forms an ink layer 16A on the gel 24. The combination of the gel 24 and the ink layer 16A forms a stack 30. The gel 24 forms a film that blocks pores of the textile fabric 18, and thus the pigment of the ink layer 16A is located at or near the surface of the textile fabric 18, which ultimately contributes to improved opacity of the white image 28B that is formed.

The processes involved in forming the stack 30 may be repeated as many times as desired to create multiple stacks 30 on the textile fabric 18. Multiple stacks 30 may contribute to increased opacity. To form a second stack on the first stack 30, the fixer fluid 14 is inkjet printed onto the stack 30, the pretreatment fluid 12 is inkjet printed onto the additional layer of fixer fluid 14 to form a second layer of gel, and the white inkjet ink 16 is inkjet printed onto the second layer of gel. It is to be understood that any desired number of stacks 30 may be generated, and in one example, the process is repeated six times to generate six stacks 30 on the textile fabric 18.

Once a desired number of stacks 30 is formed, the example shown in route B then involves thermally curing the textile fabric 18 having the stack(s) 30 thereon. This generates the white print 28B (shown in FIG. 2, route B). The thermal curing may be accomplished by applying heat or heat and pressure to the textile fabric 18 using the heating mechanism 26 as described in route A.

Route C illustrates another example printing mode.

In the example printing mode of route C, forming the gel 24 involves inkjet printing a first layer 14A of the fixer fluid 14 on the area before the pretreatment fluid 12 is inkjet printed on the area; and inkjet printing a second layer 14B of the fixer fluid 14 on the area after the pretreatment fluid 12 is inkjet printed on the area.

An applicator 22B is used to inkjet print the fixer fluid 14 on a desired area of the textile fabric 18. In this example, the fixer fluid 14 is deposited on the desired area of the textile fabric 18 to form a layer 14A. Then, the pretreatment fluid 12 is deposited on the layer 14A to form the gel 24. Then, a second layer 14B of the fixer fluid 14 is formed when the fixer fluid 14 is deposited on the gel 24 in the desired area of the textile fabric 18. In these examples, the fixer fluid 14 is used to generate both the first layer 14A and the second layer 14B. As such, the same applicator 22B is used to form both of the layers 14A, 14B.

While the second fixer fluid layer 14B is shown as being separate from the gel 24, it is to be understood that some of the fixer fluid components may react with any unreacted anionically modified cellulose nanocrystals in the gel 24 to form additional gel 24. Additionally or alternatively, the fixer fluid components may form a separate layer on the gel 24. This may be desirable for having the cationic azetidinium-containing polyamine of the fixer fluid 14 in close contact with the pigment of the white inkjet ink 16 for fixing the pigment at the surface of the textile fabric 18. The additional layer 14B of the fixer fluid 14 may contribute to increased opacity in the final print 28C as it may contribute to an increased amount of immobilized white pigment.

Once the gel 24 is formed and the second fixer fluid 14 is applied, the white inkjet ink 16 is deposited on the gel 24. The deposited white inkjet ink 16 forms an ink layer 16A on the gel 24. The combination of the gel 24 and the ink layer 16A forms a stack 30′. As described herein, this stack 30′ may also include a separate layer 14B, depending upon the interaction of the second fixer fluid 14 at the surface of the gel 24. The gel 24 forms a film that blocks pores of the textile fabric 18, and thus the pigment of the ink layer 16A is located at or near the surface of the textile fabric 18, which ultimately contributes to improved opacity of the white image 28C that is formed.

The processes involved in forming the stack 30′ may be repeated as many times as desired to create multiple stacks 30′ on the textile fabric 18. Multiple stacks 30′ may contribute to increased opacity. To form a second stack on the first stack 30′, the fixer fluid 14 is inkjet printed onto the stack 30′, and then the following fluids are printed sequentially onto the newly formed fixer fluid layer: the pretreatment fluid 12, the fixer fluid 14, and the white inkjet ink 16. It is to be understood that any desired number of stacks 30′ may be generated, and in one example, the process is repeated six times to generate six stacks 30′ on the textile fabric 18.

Once a desired number of stacks 30′ is formed, the example shown in route C then involves thermally curing the textile fabric 18 having the stack(s) 30′ thereon. This generates the white print 28C (shown in FIG. 2, route C). The thermal curing may be accomplished by applying heat or heat and pressure to the textile fabric 18 using the heating mechanism 26 as described in reference to route A.

In the example of route C, wet-on-wet-on-wet-on-wet printing is used. This type of printing is desirable in the examples disclosed herein so that the fluids 12, 14 intermingle to form the gel 24, and because the printing workflow is simplified without the additional drying. The respective fluids (14, 12, 14, 16) are deposited within a period of time ranging from about 0.01 second to about 30 seconds after the preceding fluid is printed. Wet-on-wet-on-wet-on-wet printing may be accomplished in a single pass.

In the example printing mode of route D, forming the gel involves inkjet printing a first layer of the fixer fluid 14 area before the pretreatment fluid 12 is inkjet printed on the area; and inkjet printing a second layer of the fixer fluid 14 on the area after the pretreatment fluid 12 is inkjet printed on the area, and the further includes squeegeeing the textile fabric 18 after the first layer of the fixer fluid 14 and the pretreatment fluid 12 are inkjet printed on the area and before the second layer of the fixer 14 is inkjet printed.

The printing mode in route D is similar to the printing mode described in reference to route C. However, the example of route C further includes squeegeeing the textile fabric 18 after the first layer 14A of the fixer fluid 14 and the pretreatment fluid 12 are inkjet printed on the area and before the second layer 14B of the fixer fluid 14 is inkjet printed.

In route D, an applicator 22B is used to inkjet print the fixer fluid 14 on a desired area of the textile fabric 18. As shown in route D, a layer 14A of the fixer fluid 14 is formed on the desired area of the textile fabric 18. Then, the pretreatment fluid 12 is deposited on the layer 14A to form the gel 24. The fixer fluid 14 and the pretreatment fluid 12 are applied sequentially, one immediately after the other as the applicators 22B, 22A pass over the textile fabric 18. As such, the pretreatment fluid 12 is printed onto the fixer fluid 14 while the fixer fluid 14 is wet.

The resulting gel 24 is then squeegeed. As used herein, the term “squeegeeing” means that the surface of the textile fabric 18 having the gel 24 thereon is wiped (e.g., with a squeegee or roller or other suitable mechanism) or is exposed to pressure that can flatten fibers at the surface of the textile fabric 18. The process of squeegeeing may involve moving a squeegee (shown in FIG. 2 at route D) or roller across the textile fabric 18, or by pressing the textile fabric 18 with a press (that is not heated). Squeegeeing may push the gel 24 into the textile fabric 18, which can flatten the fibers and/or better fill pores of the textile fabric 18, and may assist in mitigating fibrillation effects in printing.

While a single layer of the gel 24 may be formed and squeegeed, it is to be understood that multiple layers of gel 24 may be formed prior to squeegeeing. To form a second layer of gel on the gel 24, the fixer fluid 14 is inkjet printed onto the gel 24, and then the pretreatment fluid 12 is applied. The fluids 12, 14 have to be in contact with one another to form the gel 24, and thus when forming multiple layers of gel 24, the process should not involve forming multiple layers of fixer fluid 14 followed by multiple layers of pretreatment fluid 12. Rather, the fixer fluid 14 and pretreatment fluid 12 are applied sequentially to form the gel. It is to be understood that any desired number of gel 24 layers may be generated, and in one example, the process is repeated from three to six times to generate from three to six layers of gel 24 on the textile fabric 18. The formation of a subsequent layer of gel 24 may be repeated multiple times before all of the gel 24 layers are squeegeed at the same time.

In route D, a second layer 14B of the fixer fluid 14 is formed on the desired area of the textile fabric 18, i.e., where the gel 24 has been formed and squeegeed. In route D, the fixer fluid 14 is inkjet printed to form the second layer 14B, and thus is the same fluid used to form the first layer 14A. In this example, the fixer fluid 14 is deposited by the applicator 22B to form the second layer 14B.

The potential interactions and/or reactions taking place between the deposited fixer fluid 14 and the underlying layer(s) of gel 24 may be any of those described in reference to route C. As described, the additional layer of fixer fluid 14 may contribute to increased opacity in the final print 28D.

In the example shown in route D, once the gel 24 is formed and squeegeed and the second fixer fluid 14 is applied, the white inkjet ink 16 is deposited on the gel 24. The deposited white inkjet ink 16 forms an ink layer 16A on the gel 24. The combination of the fixer layer 14B (which may be present at the outermost surface of the gel 24) and the ink layer 16A forms a stack 30″.

The processes involved in forming the stack 30″ may be repeated as many times as desired to create multiple stacks 30″ on the squeegeed gel 24 on the textile fabric 18. Multiple stacks 30″ may contribute to increased opacity. To form a second stack on the first stack 30″, the second fixer fluid 14 is inkjet printed on the ink layer 16A, and the white inkjet ink 16 is inkjet printed onto the additional layer of the second fixer fluid 14. It is to be understood that any desired number of stacks 30″ may be generated, and in one example, the process is repeated six times to generate six stacks 30″ on the gel 24 on the textile fabric 18.

Once a desired number of stacks 30″ is formed, the example shown in route D then involves thermally curing the textile fabric 18 having the gel 24 and the stack(s) 30″ thereon. This generates the white print 28D (shown in FIG. 2, route D). The thermal curing may be accomplished by applying heat or heat and pressure to the textile fabric 18 using the heating mechanism 26 as described in reference to route A.

To further illustrate the present disclosure, an example is given herein. It is to be understood that this example is provided for illustrative purposes and is not to be construed as limiting the scope of the present disclosure.

### EXAMPLE

Anionically modified cellulose nanocrystals were used to prepare example pretreatment fluid as described herein. The anionically modified cellulose nanocrystals were modified with sulfonate groups, and were obtained from the University of Maine (referred to as “U. Maine CNC”) and from CelluForce. The sulfonated cellulose nanocrystals from the University of Maine were dissolved in water to prepare two example pretreatment fluids, PT1 and PT2. PT1 contained 3 wt % active of the sulfonated cellulose nanocrystals and PT2 contained 5 wt % active of the sulfonated cellulose nanocrystals. The sulfonated cellulose nanocrystals (Cellulose NanoCrystal Aqueous Suspension) from CelluForce were dissolved in water to prepare a third example pretreatment fluid, PT3. PT3 contained 1.5 wt % active of the sulfonated cellulose nanocrystals.

Two comparative example pretreatment fluids were also prepared with different types of commercially available methylcellulose, which are non-ionically modified (e.g., with methyl groups and/or hydroxypropyl groups). The commercially available methylcellulose was methylcellulose LV (low viscosity) (available from Modernist Pantry) and METHOCEL™ F50 (hydroxypropyl methylcellulose available from Modernist Pantry). Comparative example, Comp. PT4, contained 1.5 wt % of the methylcellulose LV and comparative example, Comp. PT5, contained 1.5 wt % of the METHOCEL™ F50.

The formulations, as well as the pH, viscosity, and surface tension, of each of the example pretreatment fluids and comparative example pretreatment fluids are shown in Table 1. The viscosity was measured at 25° C. and 3000 Hz using a Hydramotion VISCOLITE™ viscometer. The surface tension was measured using Krüss Force Tensiometer-K11.

TABLE 1
Pretreatment Fluid Formulations

| | | | | | Comp. | Comp. |
|---|---|---|---|---|---|---|
| Ingredient | Component | PT 1 | PT 2 | PT 3 | PT 4 | PT 5 |
| Anionically | U. Maine CNC | 3 wt % | 5 wt % | — | — | — |
| Modified CNC | | active | active | | | |
| | CelluForce CNC | — | — | 1.5 wt % | — | — |
| | Aqueous | | | active | | |
| | Suspension | | | | | |
| Methylcellulose | Methylcellulose | — | — | — | 1.5 wt % | — |
| | LV | | | | active | |
| | METHOCEL ™ | — | — | — | — | 1.5 wt % |
| | F50 | | | | | active |
| Water | Deionized Water | Balance | Balance | Balance | Balance | Balance |

| | | | | | |
|---|---|---|---|---|---|
| pH | 6.93 | 6.71 | 7.43 | 6.43 | 6.57 |
| Viscosity (cP) | 2.9 | 3.6 | 2.9 | 25.2 | 14.0 |
| Surface Tension (N/m) | 66.1 | 70.5 | 71.3 | 64.7 | 51.1 |

A fixer fluid and a white inkjet ink were also used in this example. The formulations are listed below in Tables 2 and 3.

TABLE 2
Fixer Fluid

| | | wt % |
|---|---|---|
| Ingredient | Specific Component | active |
| Co-solvent | 2,2-dimethyl-1,3-propanediol | 4 |
| Azetidinium-containing | POLYCUP ™ 7360A | 4 |
| polyamine | | |
| Non-ionic surfactant | SURFYNOL ® 440 | 0.3 |
| Phosphate ester | CRODAFOS ® N10A | 0.5 |
| surfactant | | |
| Water | Deionized water | Balance |

TABLE 3
White Inkjet Ink

| | Specific | |
|---|---|---|
| Ingredient | Component | wt % active |
| Pigment dispersion | White pigment | 10 |
| | dispersion | |
| Co-solvent | 1,3-propanediol | 12 |
| Non-ionic surfactant | SURFYNOL ® 440 | 0.3 |
| Binder dispersion | Polyester | 10 |
| | polyurethane | |
| Anti-decel agent | LIPONIC ® EG-1 | 2 |
| Antimicrobial agent | ACTICIDE ® B20 | 0.04 |
| Rheology modifier | Boehmite | 0.3 |
| Water | Deionized water | Balance |

To determine if pH shock was a primary cause of gel formation when the example pretreatment fluids and the fixer fluid were mixed, the fluids were mixed together and each of the fluids was mixed with different liquids. PT3 was mixed with different fluids having acidic pHs in respective vials to determine if a gel would form. In particular, PT3 was mixed with acetic acid, and comparative cationic dispersions (including 10 wt % or 52 wt % of FLOQUAT™ FL 2350 (a comparative cationic copolymer)) to determine if gelation was due to pH shock. Similarly, fixer fluid was mixed with different fluids having basic pHs to determine if a gel would form. In particular, the fixer fluid was mixed with a 5% KOH solution, an anionic polymer dispersion (including 7.9 wt % JONCRYL® 671/KOH solution), Comp. PT4, and Comp. PT5 to determine if gelation was due to pH shock.

In total, one example mixture was generated, and seven comparative mixtures were generated. The appearance of each mixture was recorded, as well as the mixture position in the vials when the vials were flipped upside down. The liquids in each mixture and the results pertaining to appearance and mixture position are shown in Table 4.

TABLE 4
Mixtures and Observations

| Mixture | | | Mixture | Mixture Flipped |
|---|---|---|---|---|
| ID | Liquid 1 | Liquid 2 | Appearance | Upside Down |
| Ex. | PT3 | Fixer Fluid | Gel | Top of Vial |
| Mixture 1 | | | | |
| Comp. | PT3 | 0.01M | Liquid | Bottom of Vial |
| Mixture 2 | | Acetic Acid | | |
| Comp. | PT3 | 10% Cationic | Loose and | Bottom of Vial |
| Mixture 3 | | Dispersion | Weak Gel | |
| Comp. | PT3 | 52% Cationic | Loose and | Bottom of Vial |
| Mixture 4 | | Dispersion | Weak Gel | |
| Comp. | 5% KOH | Fixer fluid | Liquid | Bottom of Vial |
| Mixture 5 | | | | |
| Comp. | Anionic | Fixer Fluid | Liquid | Bottom of Vial |
| Mixture 6 | Polymer | | | |
| | solution | | | |
| Comp. | Comp. | Fixer Fluid | Liquid | Bottom of Vial |
| Mixture 7 | PT4 | | | |
| Comp. | Comp. | Fixer Fluid | Liquid | Bottom of Vial |
| Mixture 8 | PT5 | | | |

When PT3 was mixed with the fixer fluid (Ex. Mixture 1), a strong gel was formed. When PT3 was mixed with an acid (Comp. Mixture 2) or the fixer fluid was mixed with a base (Comp. Mixture 5), no gel was formed. These results indicated that gel formation was not due to pH shock. Additionally, no gel was formed when the fixer fluid was mixed with the anionic polymer (Comp. Mixture 6). Loose and weak gels were formed when PT3 was mixed with the comparative cationic dispersion (Comp. Mixtures 3 and 4). When the fixer fluid was mixed with the comparative pretreatment fluids, PT4 or PT5, no gel was formed. These results indicate that the anionically modified cellulose nanocrystals and the azetidinium-containing polyamine undergo a synergistic effect that leads to strong gel formation.

The jettability performance of each of the example pretreatment fluids (PT1, PT2, PT3) was tested. The example pretreatment fluids were printed using a thermal inkjet printer. The jettability performance was evaluated using a Turn-On Energy (TOE) curve. The term “Turn-On Energy (TOE) curve,” as used herein, refers to the drop weight of the pretreatment fluid as a function of firing energy. A pretreatment fluid with good jettability performance also has a good TOE curve, where the fluid drop weight rapidly increases (with increased firing energy) to reach a designed drop weight for the pen architecture used; and then a steady drop weight is maintained when the firing energy exceeds the TOE. In other words, a sharp TOE curve may be correlated with good jettability performance. In contrast, a pretreatment fluid with a poor TOE curve may show a slow increase in drop weight (with increased firing energy) and/or may never reach the designed drop weight for the pen architecture. A poor TOE curve may be correlated with poor jettability performance. The TOE curves for the example pretreatment fluids, PT1, PT2, PT3, are shown in FIG. 3. As depicted, each of the example pretreatment fluids exhibited a good TOE curve, indicating good jettability via thermal inkjet printheads.

Prints were then generated using one or more of: the example or comparative example pretreatment fluids, the fixer fluid, and the white inkjet ink. Gildan black midweight 780 cotton T-shirts (referred to herein as GBC) were used as the textile fabric.

All of the example prints were generated with one of the example pretreatment fluids, the fixer fluid, and the white inkjet ink. In the example prints, the pretreatment fluids were respectively sandwiched between the fixer fluid. Comparative print 1 included alternating layers of the fixer fluid and white inkjet ink without any pretreatment fluid, and comparative print 2 included a repeated sequence of two layers of fixer fluid and a layer of the white inkjet ink. Comparative prints 3 and 4 were generated similarly to the example prints, except that the comparative pretreatment fluids, PT4 and PT5, were used.

Table 5 sets forth the fluids that were used to generate the various prints, the order in which the fluids were printed (i.e., the printing sequence), and the total amount of fluid that was dispensed. Each of the fluids was inkjet printed using an 11 ng thermal inkjet printhead and wet-on-wet printing. The printing sequence was repeated 6 times for each example and comparative example to reach the amount of fluid set forth in Table 5.

TABLE 5
Print Condition and Components

| | | Second | | |
|---|---|---|---|---|
| | First fluid | fluid | Third fluid | Fourth fluid |
| | printed | printed | printed | printed |
| Print sample | (gsm) | (gsm) | (gsm) | (gsm) |
| Example | Fixer fluid | PT 1 | Fixer fluid | White inkjet |
| Print 1 | (9.16 gsm) | (50 gsm) | (9.16 gsm) | ink (50 gsm) |
| Example | Fixer fluid | PT 2 | Fixer fluid | White inkjet |
| Print 2 | (9.16 gsm) | (50 gsm) | (9.16 gsm) | ink (50 gsm) |
| Example | Fixer fluid | PT 3 | Fixer fluid | White inkjet |
| Print 3 | (9.16 gsm) | (50 gsm) | (9.16 gsm) | ink (50 gsm) |
| Comparative | N/A | N/A | Fixer fluid | White inkjet |
| Print 1 | | | (9.16 gsm) | ink (50 gsm) |
| Comparative | Fixer fluid | N/A | Fixer fluid | White inkjet |
| Print 2 | (9.16 gsm) | | (9.16 gsm) | ink (50 gsm) |
| Comparative | Fixer fluid | Comp. PT 4 | Fixer fluid | White inkjet |
| Print 3 | (9.16 gsm) | (50 gsm) | (9.16 gsm) | ink (50 gsm) |
| Comparative | Fixer fluid | Comp. PT 5 | Fixer fluid | White inkjet |
| Print 4 | (9.16 gsm) | (50 gsm) | (9.16 gsm) | ink (50 gsm) |

After all of the fluids were applied, the textile fabrics were thermally cured to generate the respective example and comparative example prints. The thermal curing was performing using a heat press set at 150° C. for about 3 minutes.

The example prints and the comparative prints were tested for opacity, in terms of L*, i.e., lightness, of the white print. After the initial L* measurements were taken, each example print and the comparative example print was washed 5 times in a Whirlpool Washer (Model WTW5000DW) with warm water (at about 40° C.) and detergent and the following settings: soil level=medium; normal wash; 1 rinse. Each example print and the comparative example print was allowed to air dry between each wash. Then, the L* value of each example and comparative print was measured after the 5 washes. ΔL* was calculated by subtracting the L* taken after the 5 washed from the L* taken before the 5 washed.

The example and comparative prints were also tested for washfastness. For the washfastness test, the L*a*b* values of a color (e.g., white) before and after the 5 washes were measured. L* is lightness (as noted above), a* is the color channel for color opponents green-red, and b* is the color channel for color opponents blue-yellow. After the initial L*a*b* measurements were taken, each example print and the comparative example print was washed 5 times as described above. Then, the L*a*b* values of each example and comparative print were measured after the 5 washes. ΔE₇₆ was calculated using the CIEDE1976 color-difference formula, which is based on the CIELAB color space. Given a pair of color values in CIELAB space L*₁,a*₁,b*₁ and L*₂,a*₂,b*₂, the CIEDE1976 color difference between them is as follows:

ΔE₇₆=\sqrt{[(L*₂−L*₁)²+(a*₂−a*₁)²+(b*₁−b*₁)²]}

All L*a*b* (D50/2) measurements were taken with an X-Rite color measurement instrument. The results are shown in Table 6.

TABLE 6
Opacity and Washfastness

| | Before Wash | | | After 5 Washes | | | | |
|---|---|---|---|---|---|---|---|---|
| Print sample | L* | a* | b* | L* | a* | b* | ΔL* | ΔE₇₆ |
| Example | 93.7 | −1.4 | −1.5 | 93.9 | −1.2 | −1.5 | 0.2 | 0.3 |
| Print 1 | | | | | | | | |
| Example | 93.8 | −1.4 | −1.3 | 94.4 | −1.2 | −1.3 | 0.6 | 0.6 |
| Print 2 | | | | | | | | |
| Example | 94.4 | −1.3 | −1.2 | 94.1 | −1.2 | −1.6 | −0.3 | 0.5 |
| Print 3 | | | | | | | | |
| Comparative | 80.7 | −2.5 | −5.5 | 79.5 | −2.4 | −5.4 | −1.2 | 1.2 |
| Print 1 | | | | | | | | |
| Comparative | 86.8 | −2.1 | −3.8 | 84.6 | −2.0 | −4.3 | −2.2 | 2.3 |
| Print 2 | | | | | | | | |
| Comparative | 85.4 | −2.0 | −3.8 | 84.6 | −1.9 | −3.6 | −0.8 | 0.8 |
| Print 3 | | | | | | | | |
| Comparative | 83.6 | −2.3 | −4.6 | 83.1 | −2.2 | −4.3 | −0.5 | 0.6 |
| Print 4 | | | | | | | | |

The example prints had improved initial white opacity compared to each of the comparative prints. The example prints had an initial L* (before washing) that was at least 6.9 higher than Comparative print 2 (printed without any pretreatment fluid). The example prints also exhibited better washfastness in terms of the change in opacity (ΔL*) and ΔE₇₆ than the comparative prints. Comparative prints 3 and 4, printed with the comparative pretreatment fluids, did not improve white opacity. Overall, the example prints exhibited a smaller change in opacity and better washfastness than each of the comparative prints.

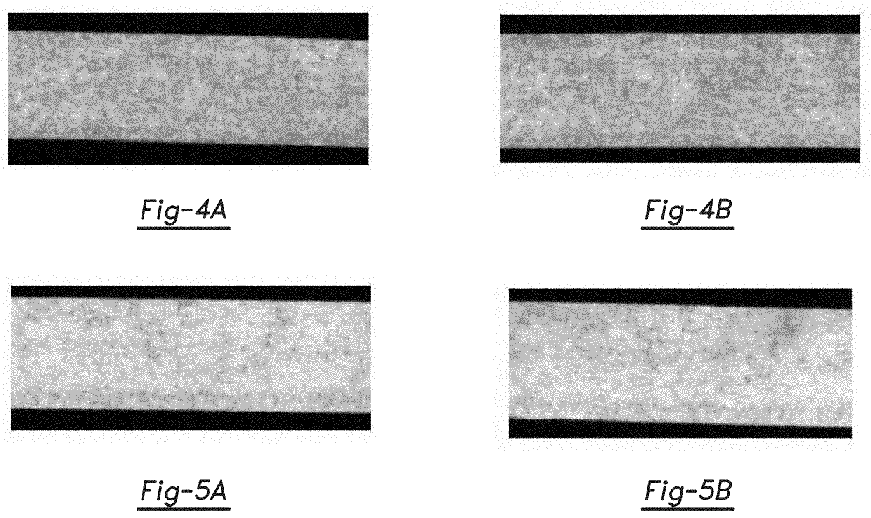

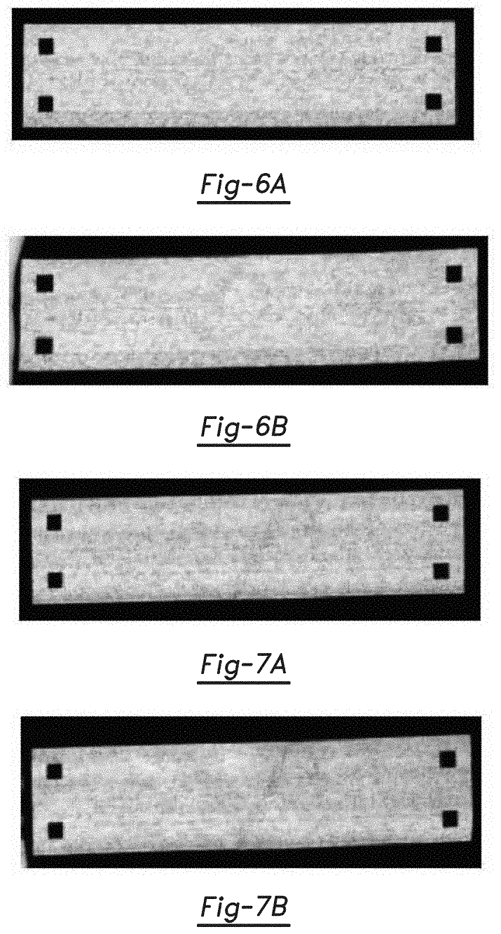

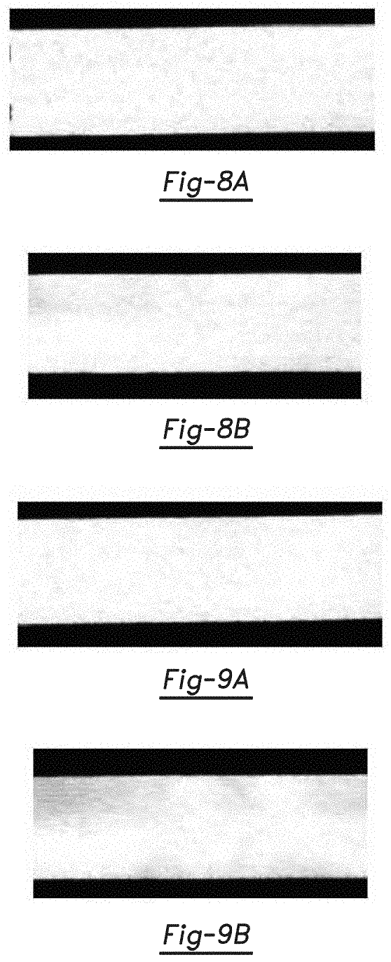

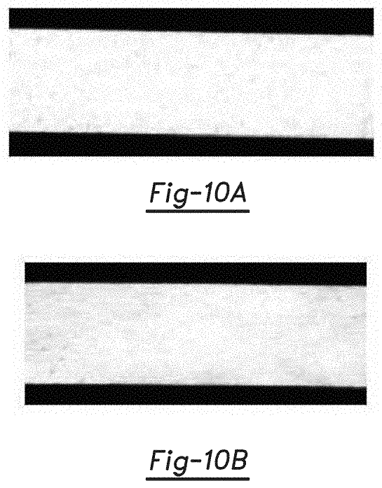

Photographs of all of the example and comparative prints were taken before washing and after the 5 washes. These photographs are reproduced herein in black and white in FIG. 4A through FIG. 10B. Comparative print 1 before washing is shown in FIG. 4A and after washing is shown FIG. 4B. Comparative print 2 before washing is shown in FIG. 5A and after washing is shown in FIG. 5B. Comparative print 3 before washing is shown in FIG. 6A and after washing is shown in FIG. 6B. Comparative print 4 before washing is shown in FIG. 7A and after washing is shown in FIG. 7B. Example print 1 before washing is shown in FIG. 8A and after washing is shown in FIG. 8B. Example print 2 before washing is shown in FIG. 9A and after washing is shown in FIG. 9B. Example print 3 before washing is shown in FIG. 10A and after washing is shown in FIG. 10B. The images corresponded with the quantitative L* values, illustrating an improvement in opacity for each of the example prints as compared to the comparative prints. The example prints were more opaque and less prone to fading after the washfastness test.

It is to be understood that the ranges provided herein include the stated range and any value or sub-range within the stated range, as if the value(s) or sub-range(s) within the stated range were explicitly recited. For example, a range from about 1 wt % active to about 20 wt % active, should be interpreted to include not only the explicitly recited limits of from about 1 wt % active to about 20 wt % active, but also to include individual values, such as about 2.15 wt % active, about 6.5 wt % active, 12.0 wt % active, 15.77 wt % active, 18 wt % active, 19.33 wt % active, etc., and sub-ranges, such as from about 5 wt % active to about 15 wt % active, from about 3 wt % active to about 17 wt % active, from about 10 wt % active to about 20 wt % active, etc. Furthermore, when “about” is utilized to describe a value, this is meant to encompass minor variations (up to +/−10%) from the stated value.

Reference throughout the specification to “one example”, “another example”, “an example”, and so forth, means that a particular element (e.g., feature, structure, and/or characteristic) described in connection with the example is included in at least one example described herein, and may or may not be present in other examples. In addition, it is to be understood that the described elements for any example may be combined in any suitable manner in the various examples unless the context clearly dictates otherwise.

In describing and claiming the examples disclosed herein, the singular forms “a”, “an”, and “the” include plural referents unless the context clearly dictates otherwise.

While several examples have been described in detail, it is to be understood that the disclosed examples may be modified. Therefore, the foregoing description is to be considered non-limiting.

What is claimed is:

1. A multi-fluid kit for inkjet textile printing, comprising:
a pretreatment fluid including:
anionically modified cellulose nanocrystals; and
a first aqueous vehicle;
a fixer fluid; and
a white inkjet ink.

2. The multi-fluid kit as defined in claim 1 wherein the anionically modified cellulose nanocrystals include carboxylate groups or sulfonate groups.

3. The multi-fluid kit as defined in claim 2 wherein a length of the anionically modified cellulose nanocrystals ranges from about 100 nm to about 200 nm and a width of the anionically modified cellulose nanocrystals ranges from about 2 nm to about 20 nm.

4. The multi-fluid kit as defined in claim 1 wherein the anionically modified cellulose nanocrystals are present in the pretreatment fluid in an amount ranging from about 0.5 wt % active to about 10 wt % active based on a total weight of the pretreatment fluid.

5. The multi-fluid kit as defined in claim 1 wherein the pretreatment fluid has a viscosity ranging from about 1 cP to about 10 cP at about 25° C.

6. The multi-fluid kit as defined in claim 1 wherein the fixer fluid includes an azetidinium-containing polyamine and a second aqueous vehicle.

7. The multi-fluid kit as defined in claim 6 wherein the azetidinium-containing polyamine includes: 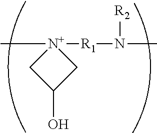
where R₁ is a substituted or unsubstituted C₂-C₁₂ linear alkyl group and R₂ is H or CH₃.

8. The multi-fluid kit as defined in claim 6 wherein the azetidinium-containing polyamine is present in an amount ranging from about 1 wt % active to about 15 wt % active based on a total weight of the fixer fluid.

9. A printing method, comprising:
forming a gel on a textile fabric by:
inkjet printing a pretreatment fluid on an area of the textile fabric, the pretreatment fluid including:
anionically modified cellulose nanocrystals; and
a first aqueous vehicle; and
inkjet printing a fixer fluid on the area of the textile fabric;
inkjet printing a white inkjet ink on the gel on the textile fabric; and
thermally curing the textile fabric having the gel and the white inkjet ink thereon, thereby generating a print.

10. The printing method as defined in claim 9 wherein forming the gel involves:
inkjet printing a first layer of the fixer fluid on the area before the pretreatment fluid is inkjet printed on the area; and
inkjet printing a second layer of the fixer fluid on the area after the pretreatment fluid is inkjet printed on the area.

11. The printing method as defined in claim 10, further comprising squeegeeing the textile fabric after the first layer of the fixer fluid and the pretreatment fluid are inkjet printed on the area and before the second layer of the fixer fluid is inkjet printed.

12. The printing method as defined in claim 9 wherein forming the gel involves:
i) inkjet printing the pretreatment fluid directly on the area of the textile fabric; and
inkjet printing the fixer fluid on the pretreatment fluid; or
ii) inkjet printing the fixer fluid directly on the area of the textile fabric; and
inkjet printing the pretreatment fluid on the fixer fluid.

13. The printing method as defined in claim 9 wherein the fixer fluid includes an azetidinium-containing polyamine and a second aqueous vehicle.

14. The printing method as defined in claim 9 wherein thermally curing the textile fabric having the gel and the white inkjet ink thereon involves heating at a temperature ranging from about 80° C. to about 200° C. for a time ranging from about 5 seconds to about 10 minutes.

15. A kit for textile printing, comprising:
a textile fabric selected from the group consisting of polyester fabrics, polyester blend fabrics, cotton fabrics, cotton blend fabrics, nylon fabrics, nylon blend fabrics, silk fabrics, silk blend fabrics, wool fabrics, wool blend fabrics, and combinations thereof;
a pretreatment fluid including:
anionically modified cellulose nanocrystals; and
a first aqueous vehicle;
a fixer fluid; and
a white inkjet ink.
